(19) United States
(12) Patent Application Publication
(10) Pub. No.: US 2016/0140305 A1
(43) Pub. Date: May 19, 2016

(54) INFORMATION COLLECTION APPARATUS AND SYSTEM FOR DIAGNOSIS SUPPORT PROGRAM, AND OPERATING METHOD

(71) Applicant: FUJIFILM Corporation, Tokyo (JP)

(72) Inventor: Shinichi TAKEYAMA, Kanagawa (JP)

(73) Assignee: FUJIFILM Corporation, Tokyo (JP)

(21) Appl. No.: 14/944,192

(22) Filed: Nov. 17, 2015

(30) Foreign Application Priority Data
Nov. 18, 2014 (JP) 2014-233642

(51) Int. Cl. G06F 19/00

(52) U.S. Cl. CPC G06F 19/345; G06F 19/322

(57) ABSTRACT

An information collection apparatus for collecting information related to a diagnosis support program with a purpose for performance monitoring is provided. The diagnosis support program is for data processing of patient health data of a patient body and for outputting diagnosis support information for reference in determining a treatment plan for the patient body. A first information collector collects judgment information of approval or non-approval as to whether the treatment plan for the patient body for which the diagnosis support program is used is based on the diagnosis support information. A second information collector collects treatment result information of a treatment result of the patient body. Preferably, the treatment result information includes at least one of occurrence or non-occurrence of rehospitalization of the patient body, a cost of hospitalization of the patient body, and a cure level of a symptom of the patient body.

### CROSS-REFERENCE TO RELATED APPLICATION

This application claims priority under 35 USC 119 from Japanese Patent Application No. 2014-233642, filed 18 Nov. 2014, the disclosure of which is incorporated by reference herein.

### BACKGROUND OF THE INVENTION

1. Field of the Invention

The present invention relates to an information collection apparatus and system for a diagnosis support program, and an operating method. More particularly, the present invention relates to an information collection apparatus and system for a diagnosis support program, and an operating method, in which information useful for encouraging development of the diagnosis support program adequate for improving a treatment result for a patient body in a hospital facility can be collected.

2. Description Related to the Prior Art

In the field of medicine, various methods have been recently suggested for improving quality of the medical service for diagnosing and treating a patient body. JP-A 2012-032920 discloses a method for generally surveying quality of the medical service of each hospital facility for medical service, such as a hospital or clinic. In the method, treatment result information of a treatment result of the patient body in the hospital facility is obtained or evaluated according to various clinical data, such as the number of days of hospitalization in the hospital facility, names of symptoms (disease, disorder or injury) of the patient body, a surgical procedure, and the like. Examples of the treatment result information include an average of the number of days of hospitalization, the number of cases of surgery, the number of patient bodies of hospitalization and check-out, an amount of payment of in-patients, a total number of in-patients, and the like.

Recently, use of a computer-executable program or diagnosis support program in the hospital facility has been spread in public for the purpose of clinically improving the treatment result. The computer-executable program receives various input data such as examination data and measured data obtained in examining the patient body, and outputs diagnosis support information by arithmetic operation of the input data for aid in determining a treatment plan for the patient body. Examples of the input data are measured values of vital signs of the patient body, such as breathing rate, pulse rate, blood pressure, body temperature and the like. Examples of the diagnosis support information are occurrence or non-occurrence of adverse effect of a drug, a proposed (alternative) drug for use, and the like. Further examples of the input data are medical images obtained by diagnostic imaging of the patient body. An example of the diagnosis support information is a proposed surgical procedure for his or her symptoms.

In one of the plural embodiments disclosed in U.S. Pat. No. 7,082,440 (corresponding to JP-A 2008-102956), the computer-executable program is constituted by the hospital facility, vendors or program providers, a center server or system server apparatus (or information collection server apparatus and an information collection apparatus), and a network. The vendors are a company, laboratory or the like for developing the computer-executable program as medical software. The center server stores the computer-executable program and manages the entirety of the computer-executable program in the manner of concentration management. The network interconnects those components in a communicable manner. Each of the vendors uploads the computer-executable program after the development to the center server. The center server stores each of the computer-executable programs for one of the hospital facilities while the computer-executable program is used in the hospital facility.

Innovation in the medical field has been recently remarkable in relation to achieving discoveries in the medical science and developing new pharmaceutical drugs according to specialized researches. Also, information of a great amount and various types is collected in the medical field to accumulate big data in association with the scientific innovation. Therefore, developing the computer-executable program is of a great concern to the vendors today in the trends of the new age.

Furthermore, a problem of an increase in total social costs for the medicine has occurred in the world according to an increase of the elderly patients. Effective development of the computer-executable program has been conceived not only by the vendors but in the human society, in view of reducing the total social costs for the medicine and cooperation for still better medical service.

However, assuming that there is no policy for developing the computer-executable program, no contribution to improving the treatment result will occur. A new product of the computer-executable program may not achieve special effects in view of medical service of good quality.

Collecting the treatment result information of the patient body suggested in JP-A 2012-032920 is effective in encouraging development of the computer-executable program for improving the treatment result. However, contribution of the computer-executable program to improving the treatment result cannot be recognized, because performance monitoring is impossible only with the treatment result of the patient body.

Assuming that auxiliary information is collected in combination with the treatment result information of the patient body, the use of the auxiliary information may be efficient in the medical field. Examples of the auxiliary information may be information related to the degree of contribution of the computer-executable program to improving the treatment result, and information of approval or non-approval of a treatment plan based on suggestion in the diagnosis support information output by the computer-executable program. However, no method for collecting and utilizing such auxiliary information is suggested in the known techniques.

### SUMMARY OF THE INVENTION

In view of the foregoing problems, an object of the present invention is to provide an information collection apparatus and system for a diagnosis support program, and an operating method, in which information useful for performance monitoring of the diagnosis support program can be collected, to encourage development of a diagnosis support program adequate for improving a treatment result for a patient body in a hospital facility.

In order to achieve the above and other objects and advantages of this invention, an information collection apparatus for collecting information related to a diagnosis support program is provided, the diagnosis support program being for data processing of patient health data of a patient body and for outputting diagnosis support information for reference in determining a treatment plan for the patient body. A first information collector collects judgment information of approval or non-approval as to whether the determined treatment plan is based on the diagnosis support information in relation to the patient body for which the diagnosis support program is used. A second information collector collects treatment result information of a treatment result of the patient body.

Preferably, furthermore, an information provider provides check sample information inclusive of the judgment information and the treatment result information in response to a request for information provision.

Preferably, furthermore, a third information collector collects clinical data associated with the patient body, the diagnosis support information being based on the clinical data for output.

Preferably, the clinical data is examination-related information of examination of the patient body.

In another preferred embodiment, the clinical data is surgery-related information of surgery of the patient body.

Preferably, furthermore, a third information collector collects clinical data associated with the patient body, the diagnosis support information being based on the clinical data for output. The information provider further provides the check sample information inclusive of the clinical data in addition to the judgment information and the treatment result information.

Preferably, the first information collector collects input history information of a history of an input of approval or non-approval of the treatment plan based on the diagnosis support information by way of the judgment information.

In one preferred embodiment, furthermore, a history information collector collects treatment history information of a history of treatment to the patient body among the patient health data. A judgment unit checks whether the treatment plan based on the diagnosis support information is approved or not according to the treatment history information. The first information collector collects a result of checking in the judgment unit for the judgment information.

Preferably, the information provider further provides check sample information inclusive of the treatment history information in addition to the judgment information and the treatment result information, the treatment history information being information after judging non-approval of the treatment plan based on the diagnosis support information in the judgment unit.

Preferably, the treatment result information includes information of at least one of occurrence or non-occurrence of rehospitalization of the patient body, a cost of hospitalization of the patient body, and a cure level of a symptom of the patient body.

Preferably, furthermore, a statistical processor statistically processes the judgment information and the treatment result information to output statistical information.

Preferably, the statistical information is a ratio of approval or a ratio of non-approval of the treatment plan based on the diagnosis support information.

In still another preferred embodiment, the statistical processor selectively retrieves the judgment information and the treatment result information according to a selection query, to obtain the statistical information.

Preferably, the selection query is an item of attribute information of the patient body.

Preferably, furthermore, a third information collector collects clinical data associated with the patient body, the diagnosis support information being based on the clinical data for output. The statistical processor further processes the clinical data statistically.

Preferably, furthermore, a statistical processor statistically processes the judgment information and the treatment result information to output statistical information. The statistical processor further processes the treatment history information statistically assuming that non-approval of a treatment plan based on the diagnosis support information is judged in the judgment unit.

Preferably, furthermore, an information provider provides check sample information inclusive of the judgment information, the treatment result information and the statistical information in response to a request for information provision.

Preferably, the second information collector collects other treatment result information of a treatment result of a non-regular patient body being different from the patient body and unrelated with the diagnosis support program. The information provider further provides the check sample information inclusive of the other treatment result information in addition to the judgment information and the treatment result information.

Also, an operating method for an information collection apparatus for collecting information related to a diagnosis support program is provided, the diagnosis support program being for data processing of patient health data of a patient body and for outputting diagnosis support information for reference in determining a treatment plan for the patient body. In the operating method, judgment information of approval or non-approval is collected as to whether the determined treatment plan is based on the diagnosis support information in relation to the patient body for which the diagnosis support program is used. Treatment result information of a treatment result of the patient body is collected.

Also, an information collection system includes a facility terminal apparatus for using a diagnosis support program for data processing of patient health data of a patient body and for outputting diagnosis support information for reference in determining a treatment plan for the patient body. An information collection server apparatus is connected with the facility terminal apparatus by network connection in a communicable manner, for collecting information related to the diagnosis support program. The information collection server apparatus includes a first information collector for collecting judgment information of approval or non-approval as to whether the determined treatment plan is based on the diagnosis support information in relation to the patient body for which the diagnosis support program is used. A second information collector collects treatment result information of a treatment result of the patient body.

Consequently, information useful for performance monitoring of a computer-executable program can be collected, because approval or non-approval can be judged for a treatment plan for a patient body in a hospital facility.

### BRIEF DESCRIPTION OF THE DRAWINGS

The above objects and advantages of the present invention will become more apparent from the following detailed description when read in connection with the accompanying drawings, in which:

FIG. 1 is a block diagram schematically illustrating a diagnosis support system;

FIG. 2 is a data chart illustrating electronic charts;

FIG. 3 is a data chart illustrating diagnostic images;

FIG. 4 is a block diagram schematically illustrating transmission and reception of information between terminal apparatuses;

FIG. 5 is a block diagram schematically illustrating databases;

FIG. 6 is a table illustrating a program list;

FIG. 7 is a table illustrating a record list;

FIG. 8 is a table illustrating a facility list;

FIG. 9 is a table illustrating a vendor list;

FIG. 10 is a block diagram schematically illustrating circuit elements in a computer for each terminal apparatus;

FIG. 11 is a block diagram schematically illustrating a CPU of a facility terminal apparatus;

FIG. 12 is a front elevation illustrating a patient health page;

FIG. 13 is a front elevation illustrating diagnosis support information with a display form;

FIG. 14 is a block diagram schematically illustrating a CPU in the vendor terminal apparatus;

FIG. 15 is a front elevation illustrating a check sample page of an initial form;

FIG. 16 is a front elevation illustrating a check sample page containing check sample information;

FIG. 17 is a block diagram schematically illustrating a CPU;

FIG. 18 is a block diagram schematically illustrating an information provider;

FIG. 19 is a flow chart illustrating control of the CPU;

FIG. 20 is a block diagram schematically illustrating a CPU of a second preferred embodiment for collecting clinical data;

FIG. 21 is a table illustrating a record list with the clinical data;

FIG. 22 is a front elevation illustrating a check sample page with the clinical data;

FIG. 23 is a table illustrating a form of a data table as statistical information;

FIG. 24 is a front elevation illustrating diagnostic support information of another preferred form;

FIG. 25 is a front elevation illustrating diagnostic support information of still another preferred form;

FIG. 26 is a front elevation illustrating a proposed drug window;

FIG. 27 is a front elevation illustrating diagnostic support information of another preferred form;

FIG. 28 is a front elevation illustrating a clinical progress window;

FIG. 29 is a block diagram schematically illustrating a CPU of a third preferred embodiment for collecting treatment history information;

FIG. 30 is a flow chart illustrating an example of approval as a result of the judgment;

FIG. 31 is a flow chart illustrating an example of non-approval as a result of the judgment;

FIG. 32 is a flow chart illustrating another example of non-approval as a result of the judgment;

FIG. 33 is a flow chart illustrating another example of approval as a result of the judgment;

FIG. 34 is a table illustrating a form of a point table;

FIG. 35 is a table illustrating a record list;

FIG. 36 is a front elevation illustrating a check sample page;

FIG. 37 is a data chart illustrating a record list;

FIG. 38 is a block diagram schematically illustrating a statistical processor and relevant circuit elements;

FIG. 39 is a front elevation illustrating a check sample page;

FIG. 40 is a table illustrating a record list with attribute information of a patient body;

FIG. 41 is a front elevation illustrating a pull down menu of the attribute information;

FIG. 42 is a front elevation illustrating a box for inputting an age;

FIG. 43 is a block diagram schematically illustrating a CPU of a sixth preferred embodiment for collecting treatment result information of a new patient body;

FIG. 44 is a block diagram schematically illustrating an information provider;

FIG. 45 is a front elevation illustrating a check sample page;

FIG. 46 is a block diagram schematically illustrating a program supply server apparatus.

### DETAILED DESCRIPTION OF THE PREFERRED EMBODIMENT(S) OF THE PRESENT INVENTION

### First Embodiment

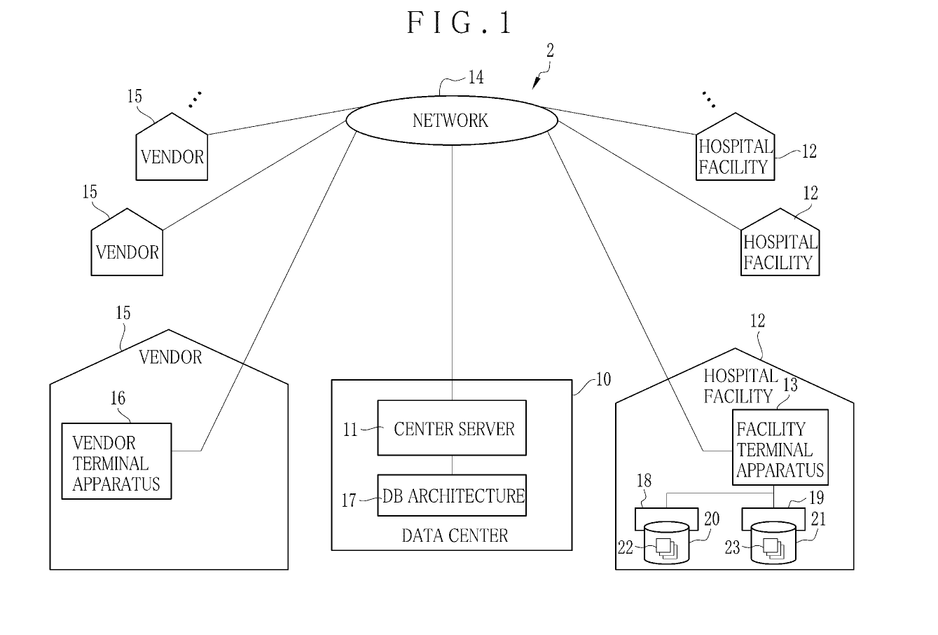

In FIG. 1, a diagnosis support system 2 includes a center server 11 or system server apparatus, a facility terminal apparatus 13 or client terminal apparatus, and a communication network 14 or system network. A data center 10 as a server node is a facility where the center server 11 is installed. A hospital facility 12 for medical service, such as a hospital or clinic, has the facility terminal apparatus 13 installed therein. The communication network 14 connects the facility terminal apparatus 13 to the center server 11 in a communicable manner. The diagnosis support system 2 corresponds to an information collection system (performance indication system) of the invention. The center server 11 corresponds to an information collection server apparatus and information collection apparatus of the invention.

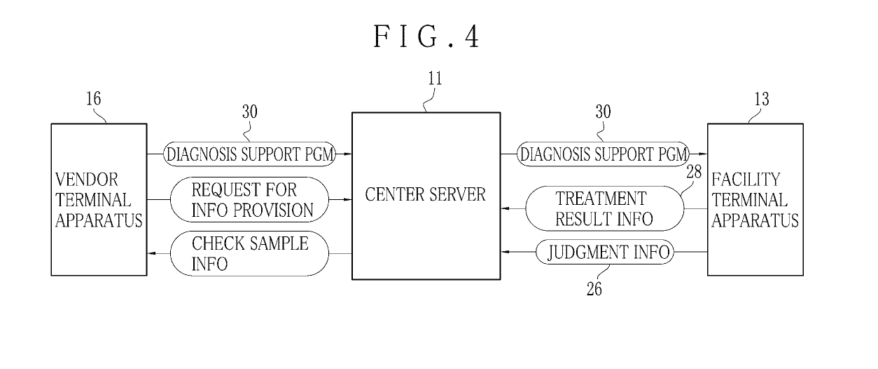

A diagnosis support program 30 or computer-executable program (see FIG. 4) is used by staff at the hospital facility 12 as a user. One of vendors 15 or program providers is a developer and manufacturer of the diagnosis support program 30. A vendor terminal apparatus 16 as an information collection apparatus is installed in each of the vendors 15, and connected with the center server 11 by the communication network 14 in a communicable manner.

The facility terminal apparatus 13 is manually operated by a doctor or operator in the hospital facility 12 for diagnosis by use of the diagnosis support program 30. The vendor terminal apparatus 16 is operated by a program developer (programmer) or programming staff of the vendor 15 for developing the diagnosis support program 30.

The data center 10 provides the service of distribution (sales), the service of download (relay), the service of information collection (providing information and performance monitoring) and the like as the service of various applications. In the service of distribution, the diagnosis support program 30 is sold from the vendor 15 to the hospital facility 12. In the service of download, functions of the diagnosis support program 30 are provided. In the service of information collection, check sample information (See FIG. 4) is provided to the vendor 15 for the purpose of performance monitoring of the diagnosis support program 30 and encouraging development of a diagnosis support program with high quality to contribute to improvement of treatment results of a patient body. The hospital facility 12 and the vendor 15 make a contract with the data center 10 for receiving service of various applications, and are registered in the data center 10 as users to use the service of the applications.

The communication network 14 is based on a specialized IP (Internet Protocol) network of a large area managed by a communication service provider as a base network. The communication network 14 is a closed network of VPN (Virtual Private Network) established in the specialized IP network of the large area. The VPN is effective in keeping security of various data without leaking to the outside of the diagnosis support system 2 from the communication network 14.

A database architecture 17 or plural databases (DBs) are provided in the data center 10. An electronic chart server apparatus 18 and an image server apparatus 19 are installed in the hospital facility 12. An intranet, such as a LAN (local area network), is used to connect the center server 11 to the database architecture 17. Also, an intranet connects the facility terminal apparatus 13 to the electronic chart server apparatus 18 and the image server apparatus 19.

An electronic chart database 20 (DB) or storage medium is established in combination with the electronic chart server apparatus 18. An image database 21 (DB) or storage medium is established in combination with the image server apparatus 19. Electronic charts 22 as patient health data are stored in the electronic chart database 20. Diagnostic images 23 as patient health data are stored in the image database 21. The image server apparatus 19 is a server according to the PACS or Picture Archiving and Communication System.

Patient health data are input to the electronic charts 22, and include patient visit data (consultation data), examination data, measured data, request data, treatment progress data and payment data. Examples of the patient visit data include results of questionnaire, finding of progress, symptom and the like. Examples of the examination data include test values of medical examination, such as blood test, biochemical test and other sample tests, and electroencephalography (EEG) and other physiological test. Examples of the measured data include measured values of vital signs, such as breathing rate, pulse rate, blood pressure, body temperature and the like. Examples of the request data are for requesting medical examination, treatment, surgery, drug administration and the like. Examples of the treatment progress data include event information of medical events of a patient body, such as a first consultation, hospitalization, check-out, rehospitalization, treatment, surgery, drug administration, complete cure and the like. Examples of the payment data include a clinical cost, drug cost, cost of hospitalization and the like. The various data in the electronic charts 22 can be input by the facility terminal apparatus 13. Also, the electronic charts 22 can be viewed and read by the facility terminal apparatus 13.

Each of the diagnostic images 23 is an image obtained by imaging of one of various modalities, such as CT (computed tomography), MRI, X-ray imaging, ultrasonic imaging, endoscopy and the like. The diagnostic images 23 are created, for example, according to the DICOM (Digital Imaging and Communications in Medicine). The diagnostic images 23 are viewed by use of the facility terminal apparatus 13.

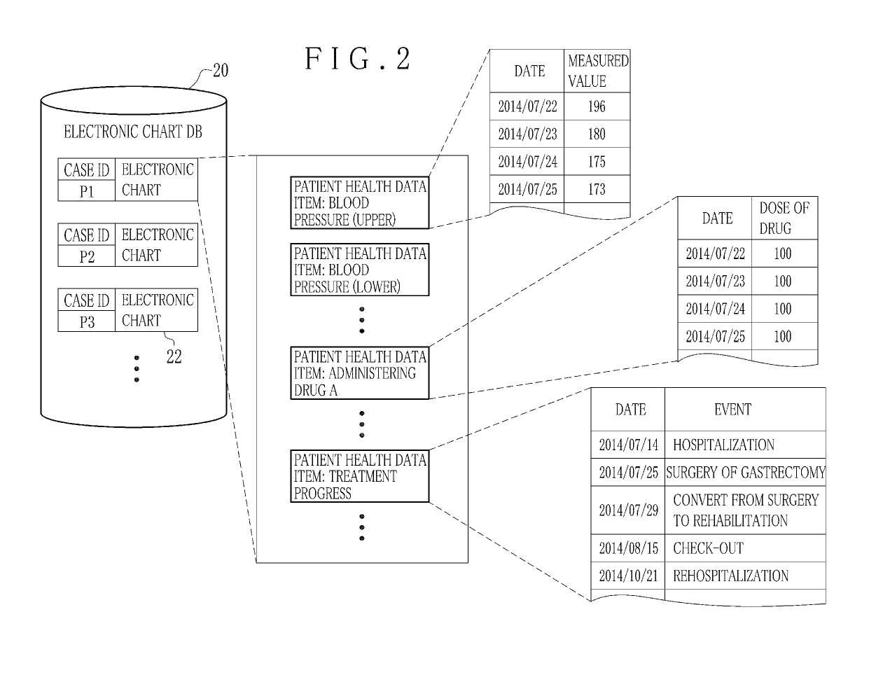

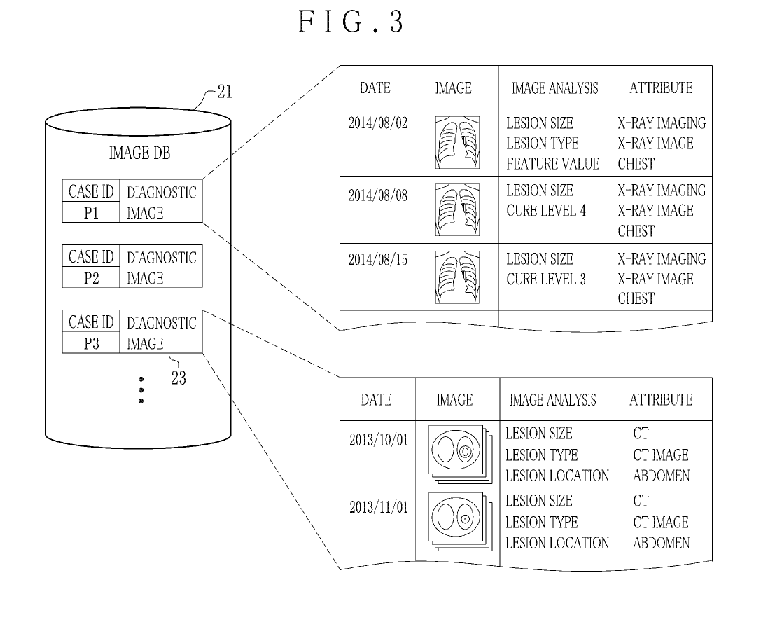

A case ID (identification data) is associated with the electronic charts 22 and the diagnostic images 23 for identifying each patient body as meta information. See FIGS. 2 and 3. The electronic charts 22 and the diagnostic images 23 can be searched from the electronic chart database 20 and the image database 21 by use of a query of the meta information, such as the case ID or the like.

In FIG. 2, the electronic charts 22 stored in the electronic chart database 20 are managed by the unit of patient bodies in association with case IDs of P1, P2, P3, . . . and so on. Attribute information and patient health data of plural items are written to the electronic charts 22 in addition to the case IDs, the attribute information including a name, address, age, sex and the like of the patient body. The patient health data are arranged by the items in a sequence of time, the items including an “Upper value of blood pressure”, “Lower value of the blood pressure”, “Drug administration (Drug A)” and “Treatment progress”. Note that the patient health data also include the above-described patient visit data, values of vital signs, request data, payment data and the like, which are not shown in FIG. 2. Examples of the vital signs are blood pressure, breathing rate, pulse rate, body temperature and the like.

Record of one case of items of patient health data contains date information and specific medical information. The date information includes a date and time of patient care, a date and time of examination, a date and time of measurement, and a date and time of drug administration (date and time of administration of the drug or use of the drug). The specific medical information includes results of questionnaire, finding of progress, test values, measured values, dose of the drug, health care cost (reward), and medical event of the patient care. In the case of the drug administration for the item, sufficient time may be required until occurrence of effect of the drug. Information of the drug administration can be “Using a predetermined dose for each one day and continuing the use for 5 days”, as drug administration of one event for a predetermined period. To this end, a date and time planned for the use of the drug are recorded for the date and time of the drug administration.

Examples of the medical events are hospitalization, surgery, conversion between the hospital departments, check-out, rehospitalization and the like illustrated in FIG. 2. Examples of surgical procedures include the “gastrectomy” for a stomach, lumpectomy for a breast cancer, coronary artery bypass surgery for angina pectoris, kidney transplantation for renal failure, and the like. In the case of surgery, an incision method is additionally combined with the surgical procedure, such as “open abdominal surgery, proximal gastrectomy”. Also, information of a margin amount (not shown) of the incision is combined with the incision method. Information of surgical time and blood loss is recorded.

The conversion is recorded for a case, for example, from the surgery department to a rehabilitation department for the purpose of recovery of functions after the surgery. Also, the conversion is recorded for a case from a surgeon in the surgery department to a physician in the internal medicine department according to a change of patient care for one patient body.

In FIG. 3, the diagnostic images 23 stored in the image database 21 are managed by respective patient bodies in association with patient IDs in the same manner as the electronic charts 22. Meta information is associated with the diagnostic images 23 as their attribute, including date information of a calendar date of imaging, image analysis information, modality information of imaging such as X-ray and CT, format information of a format of an image such as an X-ray image and CT image, and body part information such as a chest and abdomen.

In the X-ray imaging, one image is created generally in one event of the imaging. In the CT imaging, in contrast, a plurality of the diagnostic images 23 are created in one event of imaging. For this case, a common ID is allocated to the diagnostic images 23 to express that the diagnostic images 23 are derived from the single event of imaging. The diagnostic images 23 are managed as one group. This is the same assuming that a plurality of X-ray images are created in one event of the imaging.

The image analysis information relates to a position and size of a lesion in the diagnostic image 23, and a type, feature value, cure level and the like of the lesion (symptom), and the like. Assuming that the imaging is ultrasonic imaging, the image analysis information includes a measured flow rate of blood by analyzing the ultrasonic image. The image analysis information is an example of diagnosis support information obtained by image analysis with the diagnosis support program 30. Furthermore, the image analysis information can be an input from the facility terminal apparatus 13 for a result of the diagnostic image 23 viewed by a doctor.

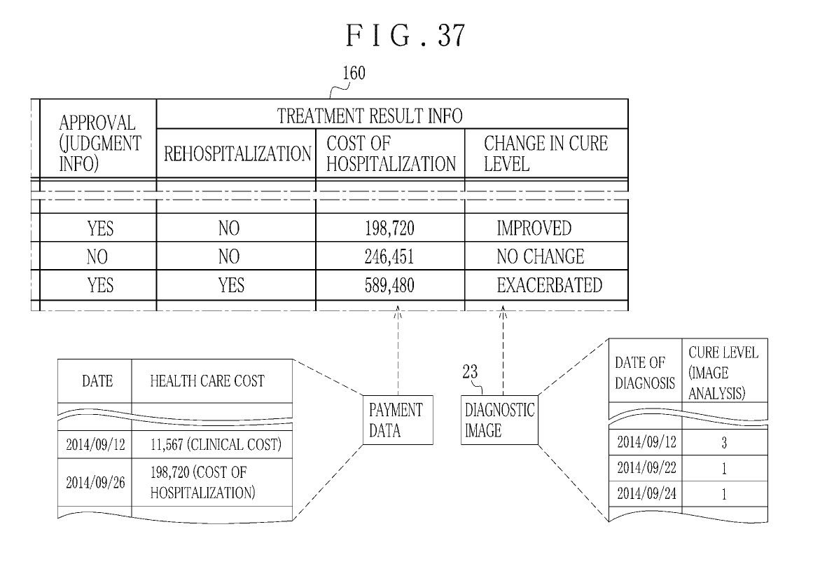

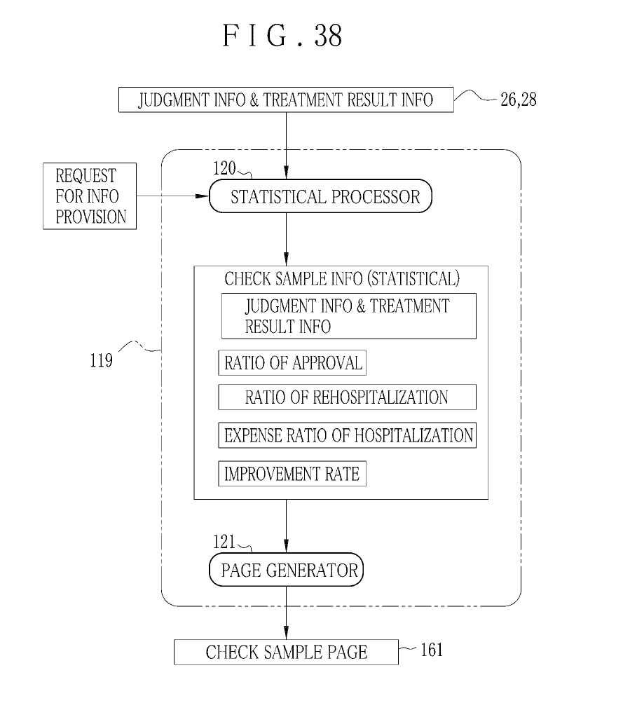

The feature value of the lesion is a value according to a pattern of the lesion, such as ground glass opacity or dots (point-like shadow). Also, the cure level of the lesion (symptom) is expressed by stepwise values according to the size of the lesion and feature value. See FIG. 37. For example, the scale of the cure level is steps 1-5. The step S is used for expressing the lowest cure level (state of exacerbation). The step 1 is used for expressing the highest cure level (state of complete cure).

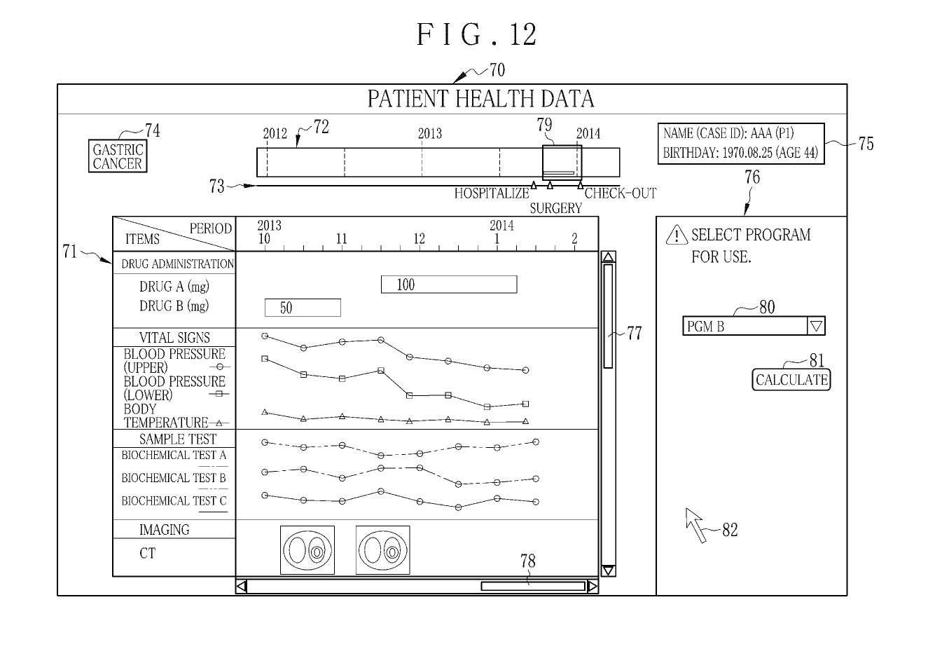

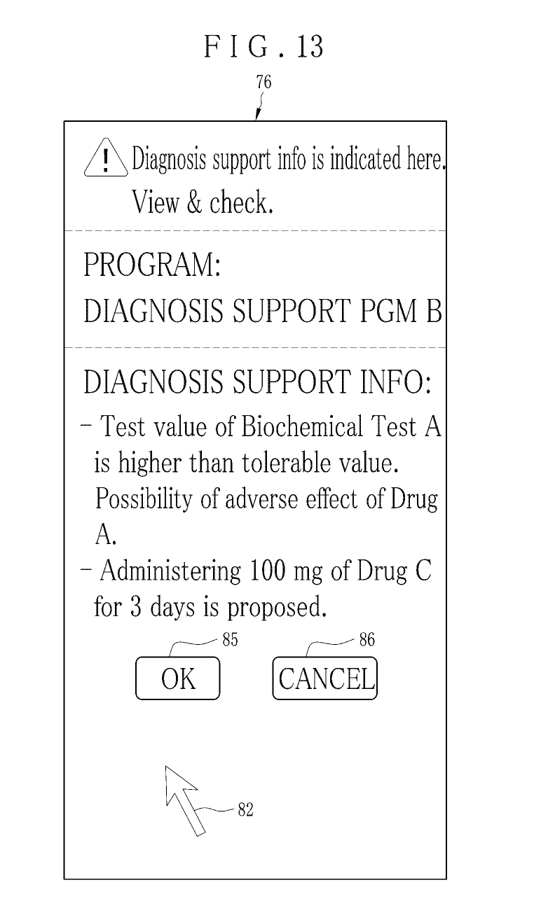

The diagnosis support program 30 performs data processing of input data of various patient health data of the patient body stored in the electronic chart database 20 and the image database 21, and outputs treatment support information to which a doctor refers for determining a treatment plan of the patient body. The diagnosis support information is displayed in a patient health page 70 of diagnosis of FIG. 12 in an overlapped manner for displaying the patient health data. See FIG. 13.

In FIG. 4, the vendor terminal apparatus 16 uploads the diagnosis support program 30 being developed to the center server 11. The center server 11 receives a plurality of the diagnosis support programs 30 uploaded by the vendor terminal apparatus 16 of the vendor 15, and stores and manages the diagnosis support programs 30 together. The center server 11 transmits the diagnosis support programs 30 to the facility terminal apparatus 13 in response to a request for downloading from the facility terminal apparatus 13.

The center server 11 receives judgment information 26 and treatment result information 28 from the facility terminal apparatus 13. The judgment information 26 is information of approval or non-approval of a treatment plan based on the diagnosis support information for the patient body for which the diagnosis support program 30 has been used for the treatment plan. The treatment result information 28 is information of a result of the treatment of the patient body. The facility terminal apparatus 13 transmits the judgment information 26 and the treatment result information 28 to the center server 11 periodically, for example, at one time per each one day in the present embodiment.

The center server 11 also receives a request for provision of check sample information from the vendor terminal apparatus 16, and responsively transmits the check sample information according to the request, inclusive of the judgment information 26 and the treatment result information 28.

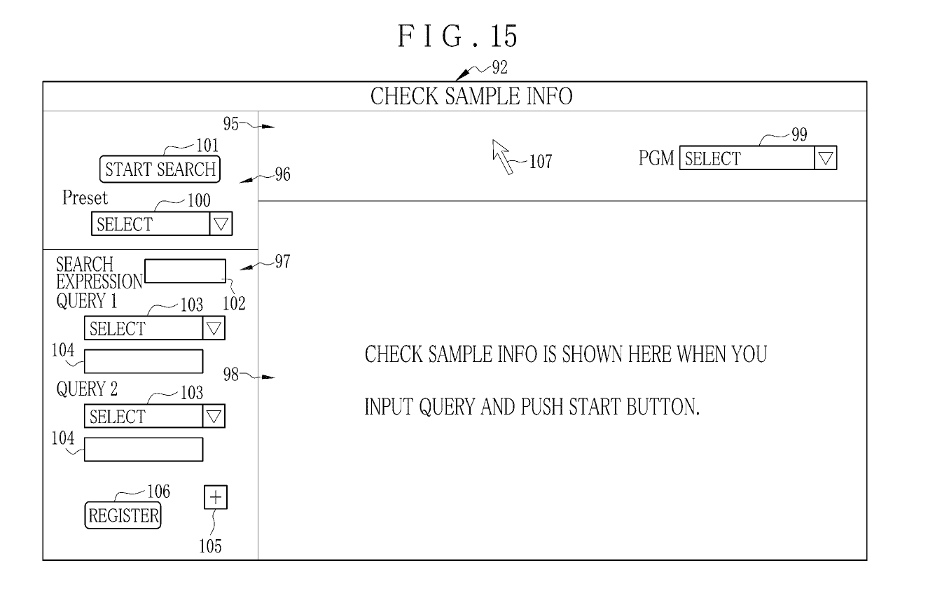

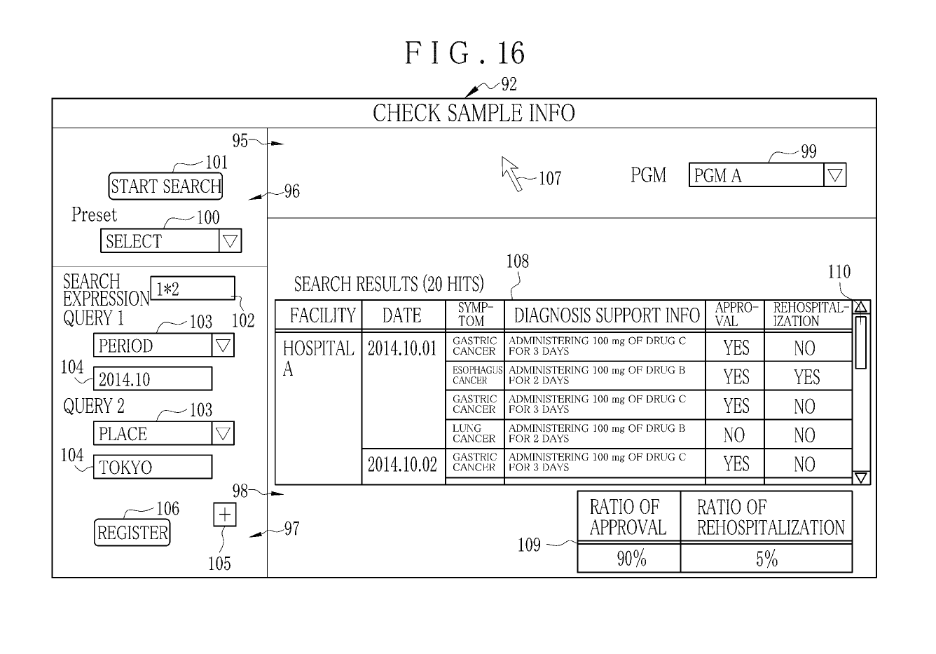

A check sample page 92 or analysis sample page is created by the center server 11 as a form of providing check sample information (See FIGS. 15 and 16). The center server 11 transmits the check sample page 92 to the vendor terminal apparatus 16.

Specifically, the center server 11 has a database web site viewable on a browser on-line for the check sample information. The center server 11 issues an authorization key to the vendor 15 having the contract of the information providing service of the check sample information, to give a right to access to the database web site. The center server 11 distributes the check sample page 92 to the vendor terminal apparatus 16 in a format of XML data for web distribution created according to the XML (Extensible Markup Language) as a markup language. The vendor terminal apparatus 16 performs display processing to display the check sample page 92 on the web browser according to the XML data. In short, the vendor terminal apparatus 16 functions also as a viewing terminal apparatus for the check sample information. Also, it is possible to use another data description language instead of the XML, such as JSON (JavaScript Object Notation) and the like, JavaScript being a trade name.

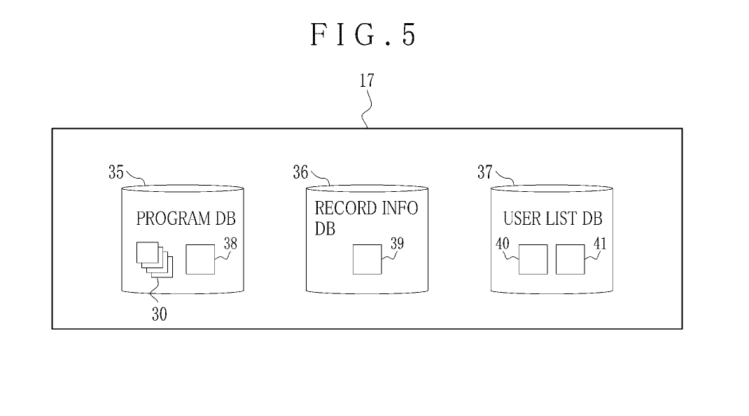

In FIG. 5, the database architecture 17 in connection with the center server 11 includes a program database 35 (DB) or storage medium, a record information database 36 (DB) or storage medium for judgment and treatment results, and a user list database 37 (DB) or storage medium. A program list 38 and the diagnosis support programs 30 are stored in the program database 35. A record list 39 with judgment information and treatment result information is stored in the record information database 36. A facility list 40 and a vendor list 41 or program provider list are stored in the user list database 37.

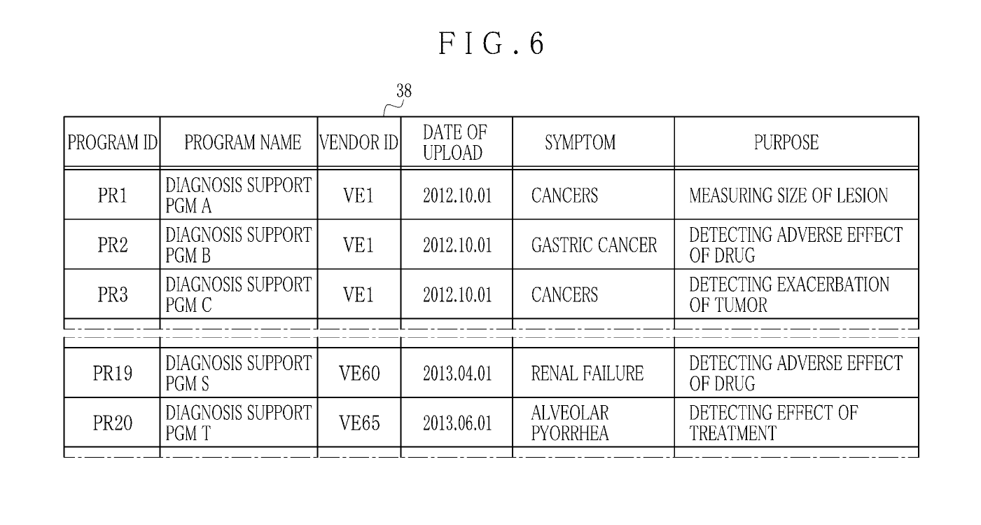

In FIG. 6, the program list 38 includes various items such as the program ID, program name, vendor ID, date of uploading, clinical symptom, and use.

The program ID is an ID for the center server 11 to manage the diagnosis support programs 30 discretely, and is automatically allocated by the center server 11 upon uploading of the diagnosis support programs 30 from the vendor terminal apparatus 16. The program name is a name of each of the diagnosis support programs 30 given by the vendors 15. The vendor ID is an ID for the center server 11 to manage the vendors 15 discretely, and is automatically allocated at the time of the service registration (contract). For an item of the vendor ID, a vender ID of the vendor 15 after the development of the relevant one of the diagnosis support programs 30 is registered. The date of upload is a date of uploading the diagnosis support program 30 to the center server 11.

The clinical symptom is a symptom for which the vendor 15 proposes the use of the diagnosis support program 30. A registered example of the clinical symptom can be “Gastric cancer” as a single disease, but can be “Cancers” as a group of plural diseases (syndromes or complications) without limitation to a single disease. Furthermore, a set of combined symptoms or complications, such as “Diabetes and renal failure” (not shown), can be registered for the item of the clinical symptom.

The use in the program list 38 is a main use of the diagnosis support program 30. To the field of an item of the use, “measurement of a size of a lesion” is registered for the diagnosis support program 30 for measurement of a size of a lesion, or “detection of adverse effect of a drug” is registered for the diagnosis support program 30 for detection of adverse effect of a drug, or “detection of exacerbation of a tumor” is registered for the diagnosis support program 30 for detection of exacerbation of a tumor.

Items of the clinical symptom and use are input by the vendor 15 through the vendor terminal apparatus 16 at the time of uploading the diagnosis support program 30. Note that registering the clinical symptom and use is not necessary. Spaces for those items may remain blank for the diagnosis support program 30 in which those are not determined. Also, it is possible to add various items to the program list 38, the items including the program ID allocated by the vendor 15 besides the program ID allocated by the center server 11, version information of the diagnosis support program 30, a facility ID of the hospital facility 12 of downloading the diagnosis support program 30, and the like.

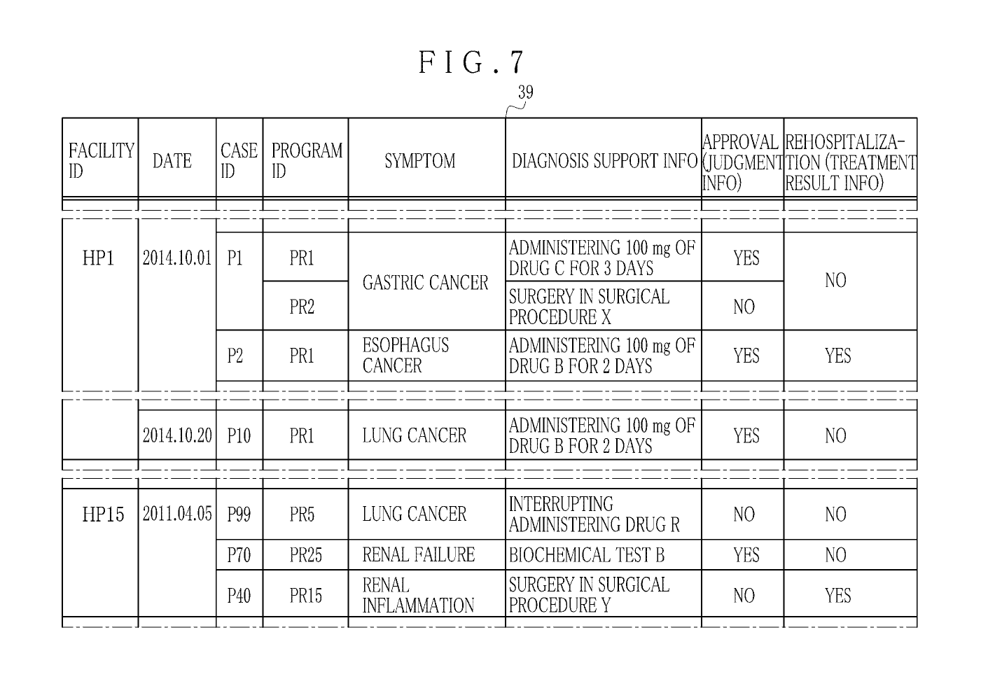

In FIG. 7, the record list 39 contains various items, including the facility ID, a calendar date of use, case ID of a case (patient body), program ID, particular symptom, diagnosis support information being output, judgment information and treatment result information. The facility ID is used for the center server 11 to manage the hospital facility 12. The center server 11 automatically issues the facility ID at the time of the service registration in the same manner as the vendor ID.

The date of the use is a date of the patient care by use of the diagnosis support program 30. The case ID of the patient body with which the diagnosis support program 30 is used is recorded for the item of the case ID. The program ID of the diagnosis support program 30 is recorded for the item of the program ID.

The particular symptom (disease, disorder or injury) for use is in correspondence in a clinical symptom in the program list 38. In the field of the particular symptom (disease, disorder or injury), a symptom of the patient body for which the diagnosis support program 30 is used is registered. An example of items in the diagnosis support information is information output by the diagnosis support program 30, such as “Administering 100 mg of Drug C for 3 days”, “Surgery in the Surgical Procedure X”, “Interruption of administering Drug R”, and the like.

For the item of the judgment information, approval or non-approval of a treatment plan based on a suggestion of the diagnosis support information being recorded is recorded. For example, let the facility ID be “HP1”. Let the date of the use be “2014.10.01” or “1 October 2014”. Let the patient ID be “P1”. Ina row of those items, “Yes” is recorded for judgment information of “PR1” of the program ID to express approval of “Administering 100 mg of drug C for 3 days” in the diagnosis support information. “No” is recorded for judgment information of “PR2” of the program ID to express non-approval of “Surgery in the Surgical Procedure X” in the diagnosis support information.

Occurrence or non-occurrence of rehospitalization of the patient body is recorded in the item of the treatment result information. The rehospitalization is checked by referring to description of the treatment progress data in the electronic charts 22 of the patient body. Specifically, assuming that the “rehospitalization” is input for the medical event in the treatment progress data, “Yes” is registered in the item of the treatment result information. In case of no rehospitalization, “No” is registered. Note that a form of storing the judgment information and treatment result information is not limited to registering to the record list 39 in a combined manner in the present embodiment. The judgment information and treatment result information can be registered in lists discrete from one another, and can be associated with one another by use of a common ID for management.

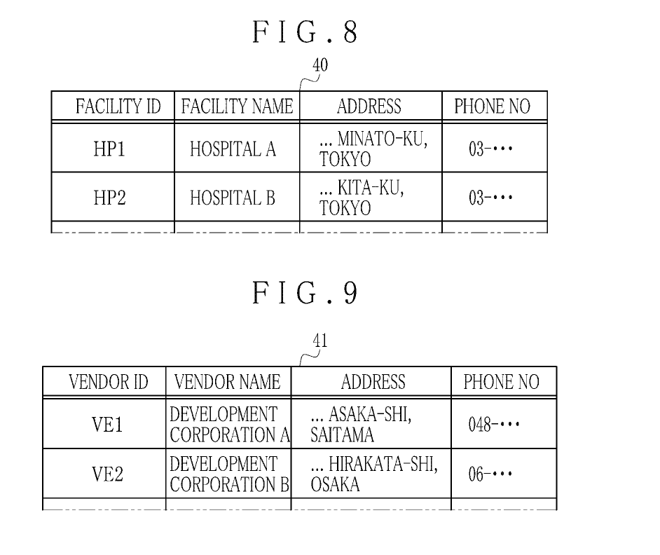

In FIG. 8, the facility list 40 has various items including the facility ID, facility name, address (place), and telephone number. The facility name is the name of the hospital facility 12. The address of the hospital facility 12 is registered in the item of the place. A representative telephone number of the hospital facility 12 is registered in the item of the telephone number.

Also, it is possible to add various items of information to the facility list 40, including doctor information, facility information, address information and the like. The doctor information includes an ID and name of a doctor in the hospital facility 12, his or her hospital department and medical field, and the like. The facility information includes a medical association to which the hospital facility 12 belongs, medical equipment, number of beds and number of staff members of the hospital facility 12. The address information can be a URL (uniform resource locator) of a web site of the hospital facility 12.

In FIG. 9, the vendor list 41 includes items of the vendor ID, vendor name, address (place) and telephone number. In the same manner as the facility list 40, the name, address and representative telephone number of the vendor 15 are registered in the items of the vendor name, address and telephone number. It is possible to add various data to the items of the vendor list 41 in the same manner as the facility list 40, inclusive of programmer information of a programmer at the vendor 15, such as a programmer ID, and a URL (uniform resource locator) of a web site of the vendor 15.

The center server 11, the facility terminal apparatus 13 and the vendor terminal apparatus 16 are based on a computer, such as a server computer, personal computer, workstation or the like, and constituted by installation of a control program such as the Operating System (OS), and a server program, client program or other application program.

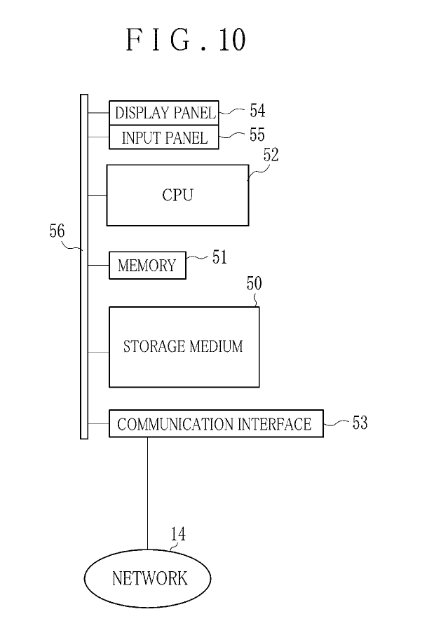

In FIG. 10, the computers constituting those terminal apparatuses, inclusive of the center server 11, are basically the same. Each computer includes a storage medium 50, a memory 51, a CPU 52 (central processing unit), a communication interface 53, a display panel 54 and an input panel 55 or input interface. A data bus 56 interconnects those circuit elements.

The storage medium 50 is a hard disk drive incorporated in a computer constituting the center server 11 or the like or connected to the computer by a cable, network or the like. Also, the storage medium 50 may be a disk array having plural hard disk drives. The storage medium 50 stores a control program and various application programs such as the Operating System (OS), and display image data for operation pages associated with the programs.

The memory 51 is a working memory with which the CPU 52 performs tasks. The CPU 52 loads the memory 51 with the programs read from the storage medium 50, and controls the various elements in the computer by processing according to the programs.

The communication interface 53 is a network interface for transmission control of various data by use of the communication network 14. The display panel 54 displays various control pages according to operation of the input panel 55, such as a mouse, keyboard or the like. A function of input is provided in the control page according to the GUI (Graphical User Interface). The computer for the center server 11 or the like receives inputs of command from the input panel 55 by use of the control page.

Note that a letter A is added to numerals for the elements in the center server 11. B is added to numerals for the elements in the facility terminal apparatus 13. C is added to numerals for the elements in the vendor terminal apparatus 16.

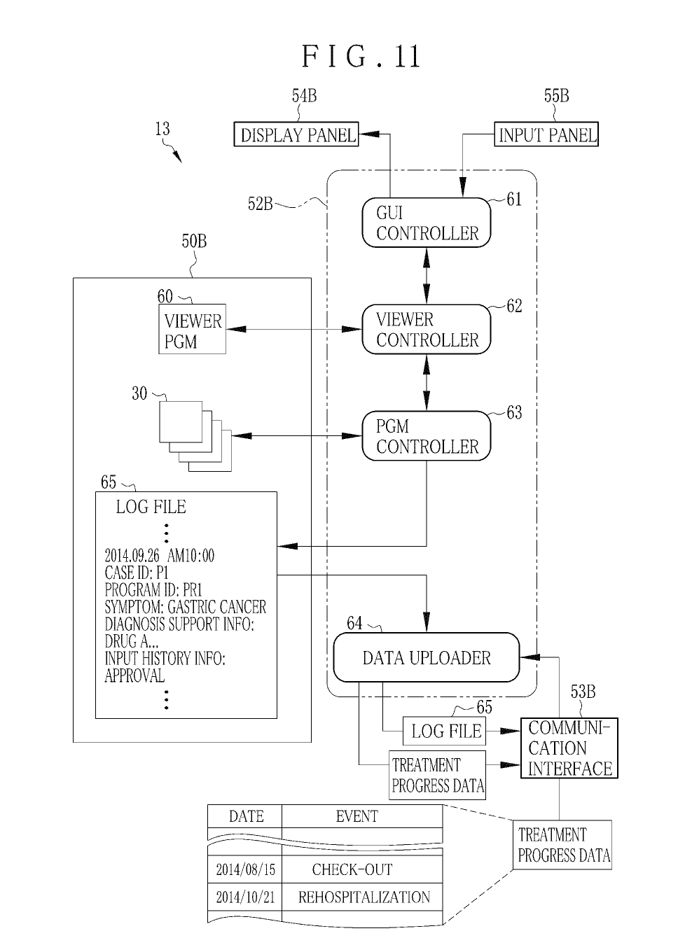

In FIG. 11, a storage medium 50B in the facility terminal apparatus 13 stores the diagnosis support program 30 and a viewer program 60 or software downloaded from the center server 11. The viewer program 60 is software supplied by the center server 11 at the time of the service registration (contract). The viewer program 60 controls display of patient health data, and causes the diagnosis support program 30 to display the diagnosis support information in the patient health page 70.

A CPU 52B (central processing unit) in the facility terminal apparatus 13, in response to running the viewer program 60, starts functioning with a memory 51B (not shown) by way of a GUI controller 61, a viewer controller 62, a program controller 63 and a data uploader 64 or information output unit for judgment and treatment results.

A display panel 54B is caused to display the patient health page 70 by the GUI controller 61. An input panel 55B or input interface is used to input command signals through the patient health page 70. The GUI controller 61 receives the command signals for transfer to the viewer controller 62.

The viewer controller 62 controls the function of the viewer program 60. The viewer controller 62 generates a start page, where an input of a case ID is received. The viewer controller 62 transmits a data request to the electronic chart server apparatus 18 and the image server apparatus 19 for distribution of patient health data according to a query of the case ID received in the start page. The viewer controller 62 receives the patient health data from the electronic chart server apparatus 18 and the image server apparatus 19 after the request, generates the patient health page 70, and outputs the patient health page 70 to the GUI controller 61.

In the viewer controller 62, the patient health page 70 receives various command inputs including selection of the diagnosis support program 30 for use, arithmetic operation in the diagnosis support program 30, and judgment in relation to approving a treatment plan based on suggestion in the diagnosis support information. Also, the viewer controller 62 transfers patient health data to the program controller 63 as input data to the diagnosis support program 30.

The program controller 63 controls operation of the diagnosis support program 30. Namely, the diagnosis support program 30 is run while controlled by the program controller 63. In case the viewer controller 62 receives a command signal for arithmetic operation, the program controller 63 runs the diagnosis support program 30 in a condition according to the received command signal at the viewer controller 62. Patient health data from the viewer controller 62 is input for the diagnosis support program 30 to perform calculation, so that the diagnosis support program 30 outputs diagnosis support information.

The program controller 63 transfers the diagnosis support information to the viewer controller 62. The viewer controller 62 performs display processing to display the diagnosis support information on the patient health page 70 in an overlapped manner.

A log file 65 is written by the program controller 63 to the storage medium 50B as expression of a history of arithmetic operation of the diagnosis support program 30 at each time of the arithmetic operation in the diagnosis support program 30. The log file 65 includes various data, such as a date and time of the arithmetic operation in the diagnosis support program 30, a case ID of the patient body, a program ID of the diagnosis support program 30 for the arithmetic operation, particular symptom, diagnosis support information of output, and input history information which is a history in inputting the judgment of the treatment plan according to the suggestion of the diagnosis support information as judgment information.

A communication interface 53B is connected to the data uploader 64. The data uploader 64 uploads the log file 65 to the center server 11 by use of the communication interface 53B, periodically, for example, per one day, the log file 65 including the input history information as judgment information of one day. The data uploader 64 accesses the electronic chart database 20, and retrieves treatment progress data in the electronic chart 22 for the patient body, inclusive of occurrence or non-occurrence of rehospitalization as treatment result information. The data uploader 64 uploads the treatment progress data to the center server 11 with the log file 65 by use of the communication interface 53B. The log file 65 and the treatment progress data are uploaded by the data uploader 64 automatically per one day according to the control of the viewer program 60.

In FIG. 12, the patient health page 70 includes a clinical data area 71, a period area 72 with surgery-related information (as clinical data), an event area 73, a symptom area 74, a personal area 75 and a diagnosis support area 76 with diagnosis support information.

The clinical data area 71 is a two-dimensional area with horizontal and vertical axes. Names of the various items of patient health data are displayed and arranged in the vertical direction. A period (first period) of acquiring the patient health data in the entirety of the progress of the care of the patient body is indicated in the clinical data area 71 in the horizontal direction. Examples of the items of the patient health data include data categories, such as the “drug administration”, “vital signs”, “sample test”, “medical imaging”, and items of specific data, such as “Drugs A and B”, “upper and lower values of blood pressure and body temperature”, “Biochemical Tests A, B and C”, and “CT imaging”. In FIG. 12, the first period is approximately three months and a half from October of 2013 to the middle of January of 2014.

The clinical data area 71 displays various data such as a bar for expressing dates of start and end of the drug administration in the first period and a dose of the drug, a line chart created by connecting points of plotting measured values of the vital signs and test values of the sample test in the first period, and thumbnail images of the diagnostic images 23 formed in the first period. The measured values or test values to be plotted for the bar or line chart and the thumbnail images are arranged according to a date and time of the drug administration, a date and time of the measurement and a date and time of the examination. Scroll bars 77 and 78 are disposed for scrolling the clinical data area 71 in vertical and horizontal directions.

The period area 72 is an area for displaying a second period relatively longer than the first period displayed in the clinical data area 71. A date range 79 for surgery-related information (as clinical data) is displayed in the period area 72, and is information of a range of the first period included in the second period. A length of the date range 79 corresponds to a horizontal size of the first period in the graph of the second period. In FIG. 12, the first period is approximately three months and a half. The date range 79 corresponds to approximately three months and a half within the second period.

In relation to the date range 79, the period area 72 moves horizontally in response to operation of the scroll bar 78. Also, the date range 79 is movable itself in the horizontal direction, or has a changeable size, so as to change a display range of the first period. The first period displayed initially can be before retrieval of the newest patient health data by a predetermined length of time, and can be manually set by a doctor at the time of inputting a case ID in the start page.

The event area 73 indicates a date and time of a medical event in the progress of care of a patient body, such as dates of hospitalization and check-out, surgery date, and the like. The symptom area 74 indicates a symptom (disease, disorder or injury) of the patient body of a patient ID input in the start page. The symptom displayed in the symptom area 74 is recorded to the log file 65 as the particular symptom by the program controller 63. The symptom in the symptom area 74 can be extracted from description of the symptom in the patient visit data (consultation data) of the electronic chart 22, and can be information manually input by a doctor upon inputting the case ID in the start page. The personal area 75 indicates basic information input in the start page according to the case ID, such as a patient name, case ID, birthday and the like.

In the diagnosis support area 76, a message text, a pull down menu 80 and a process button 81 for arithmetic operation are displayed. The message text encourages a user to select the diagnosis support program 30 for use. The pull down menu 80 and the process button 81 are used for selecting the diagnosis support program 30. The pull down menu 80 is operated to input a signal of the selection to the viewer controller 62. The process button 81 is operated to input a command signal for the arithmetic operation to the viewer controller 62.

The pull down menu 80 displays the name of the diagnosis support program 30 stored in the storage medium 50B as a selection option. A program ID of the diagnosis support program 30 selected in the pull down menu 80 is written to the log file 65 by the program controller 63. In FIG. 12, the “Diagnosis Support Program B” is selected in the pull down menu 80.

A cursor 82 is used to designate and click the process button 81 with a mouse after selecting the diagnosis support program 30 with the pull down menu 80. Then a program ID of the diagnosis support program 30 selected in the pull down menu 80 is transferred to the program controller 63 by the GUI controller 61 and the viewer controller 62. The diagnosis support program 30 performs arithmetic operation while controlled by the program controller 63. Note that examples of the patient health data transferred to the program controller 63 as input data from the viewer controller 62 may be predetermined for respectively the diagnosis support program 30, but may be manually designated by a doctor or operator with the patient health page 70.

In FIG. 13, the diagnosis support area 76 is changed over upon receiving output from the diagnosis support information from the diagnosis support program 30. The diagnosis support area 76 displays a message for encouraging check of the diagnosis support information, name of the diagnosis support program 30 for use, and the diagnosis support information. An OK button 85 and a cancel button 86 for judgment information are displayed in the diagnosis support area 76 for receiving an input of approval or non-approval of a treatment plan, which is based on the suggestion of the diagnosis support information. In FIG. 13, an example of the diagnosis support program 30 for use is “Diagnosis Support Program B”. Examples of the diagnosis support information is a finding for measured values of the “Biochemical Test A”, and proposal of a use of “Drug C” which is alternative to “Drugs A and B”.

The OK button 85 and the cancel button 86 generate inputs to the viewer controller 62 for approval or non-approval. The OK button 85 and the cancel button 86 are disposed directly under the comment for proposing the use of “Drug C”, and used for selecting approval or non-approval of the use of “Drug C” as a treatment plan.

In case the OK button 85 is clicked, a request of “Administering 100 mg of Drug C for 3 days” according to the proposal for use of Drug C is performed automatically. The patient health data of the items of the drug administration in the electronic chart 22 of the patient body is automatically updated. The program controller 63 records information of “approval” to the log file 65 as the diagnosis support information and input history information. Then the diagnosis support area 76 is returned to a display state of FIG. 12.

Assuming that the cancel button 86 is clicked, the diagnosis support area 76 becomes returned to the display form of FIG. 12 without updating the request for the drug administration or updating the patient health data. The program controller 63 writes the diagnosis support information and the input history information of “Non-approval” to the area of the log file 65.

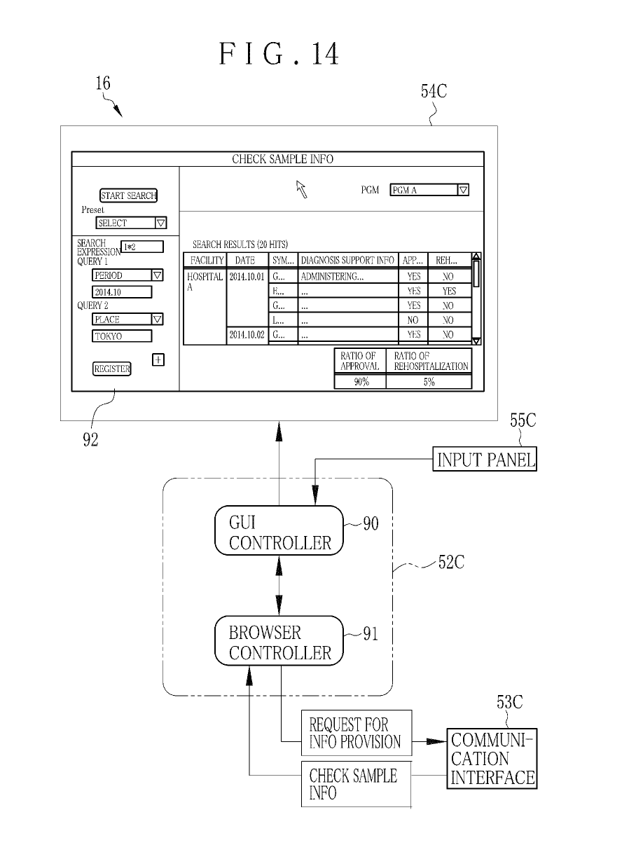

In FIG. 14, a CPU 52C (central processing unit) in the vendor terminal apparatus 16 starts up a web browser as an application program. A memory 51C (not shown) cooperates with the CPU 52C. A GUI controller 90 and a browser controller 91 are caused in the CPU 52C to function by the application program. An input panel 55C or input interface is operated to perform access to the center server 11 in the control of the GUI controller 90 and the browser controller 91, to perform authentication to a database web site for on-line access.

A display panel 54C is controlled by the GUI controller 90 to display the check sample page 92. The GUI controller 90 receives an input of a command signal from the input panel 55C with the check sample page 92, and transfers the command signal to the browser controller 91.

The browser controller 91 controls the web browser. The browser controller 91 generates a request to the center server 11 by use of a communication interface 53C, the request being for information provision according to an input of the input panel 55C by use of the GUI controller 90. Also, the browser controller receives check sample information (analysis sample information) transmitted from the center server 11 to the communication interface 53C, specifically, XML data (or data of the JSON format) of the check sample page 92. The browser controller 91 produces the check sample page 92 to be displayed on the web browser according to the XML data (or data of the JSON format), and outputs the check sample page 92 to the GUI controller 90.

In FIGS. 15 and 16, the check sample page 92 includes a program selection area 95, a Boolean search selection area 96 for preset Boolean search, a search query area 97, and a sample display area 98 with a check sample or analysis sample.

A pull down menu 99 is displayed in the program selection area 95 for selecting the diagnosis support program 30. The pull down menu 99 indicates names of all the diagnosis support programs 30 as selection options registered in the program list 38, or one of the diagnosis support programs 30 uploaded by the vendor terminal apparatus 16 of the vendor 15 viewing the check sample page 92 among the diagnosis support programs 30.

The Boolean search selection area 96 includes a pull down menu 100 and a search button 101, which are used for selecting preset Boolean search expressions registered previously.

The search query area 97 has a Boolean search box 102 for input, a pull down menu 103, a search query box 104, an add button 105 and a register button 106. The Boolean search box 102 is for inputting a Boolean search expression. The pull down menu 103 is for selecting a selection query (key item). The search query box 104 is for inputting a search query. The add button 105 is for adding a new set of the pull down menu 103 and the search query box 104. The register button 106 is for registering the Boolean search expression input in the Boolean search box 102 as a preset Boolean search expression.

In the Boolean search box 102, Boolean search expressions for designating AND search, OR search, NOT search and the like are input by designating logical operators of AND, OR, NOT and the like in the sets. The pull down menu 103 displays a plurality of selection queries as selection options. Preset examples of the selection queries are a period, facility name of the hospital facility 12, place of the hospital facility 12, particular symptom, purpose (use) and the like.

Note that it is possible to search the check sample information (analysis sample information) only by selective input of a set of the pull down menu 103 and the search query box 104 without selecting the diagnosis support program 30 in the pull down menu 99. Also, the check sample information can be searched only by selecting the diagnosis support program 30 in the pull down menu 99 without selective input of the set of the pull down menu 103 and the search query box 104.

FIG. 15 illustrates an initial view of the check sample page 92 to be displayed initially on a web browser after access authorization to the database web site. In the initial view, no check sample information is displayed in the sample display area 98, which indicates a message for encouraging an input of a search query.

The diagnosis support program 30, selection queries, search query and the like are selectively input by the pull down menus 99 and 103 and the search query box 104. A cursor 107 points the search button 101 before clicking is performed by use of a mouse. A request for supply of the check sample information (analysis sample information) is generated to the center server 11 from the browser controller 91 through the communication interface 53C.

In FIG. 16, “Diagnosis Support Program A” is input by use of the pull down menu 99. Selection queries of “Period” and “Place” are input by use of the pull down menu 103. “2014.10” or “October 2014” and “Tokyo” are input by use of the search query box 104. A search expression “1*2” for an AND search of queries 1 and 2 is input by use of the Boolean search box 102. In case the search button 101 is clicked, the check sample page 92 is generated and output by the center server 11. A check sample list 108 or analysis sample list, and a ratio display area 109 with statistical information for judgment and hospitalization are displayed in the sample display area 98 for the Diagnosis Support Program A of October of 2014 of the hospital facility 12 located in Tokyo.

In the check sample list 108, various items are displayed in the same manner as those in the record list 39 except for the case ID and program ID, the items including a date of use, particular symptom, the diagnosis support information, approval or non-approval, and occurrence or non-occurrence of rehospitalization. Also, an item of a name of the hospital facility is provided in place of the facility ID in the record list 39. Also, a scroll bar 110 is disposed to scroll the check sample list 108 in the vertical direction. Assuming that the check sample information is searched by selecting inputs of the set of the pull down menu 103 and the search query box 104 without selecting the diagnosis support program 30 in the pull down menu 99, an item of the program ID is provided in the check sample list 108.

The ratio display area 109 displays a ratio of approval and a ratio of rehospitalization. The ratio of approval is a ratio of the number of cases with the record of “Yes” for the approval or non-approval among the cases of all the check sample information displayed in the check sample list 108. The ratio of rehospitalization is a ratio of the number of cases with the record of “Yes” for the occurrence or non-occurrence of rehospitalization among the cases of all the check sample information displayed in the check sample list 108. Let the number of cases be 18 with the record of “Yes” for the approval among 20 cases of all the check sample information in the check sample list 108. The ratio of approval is 18/20=0.9, namely 90%. Let the number of the case be one (1) with the record of “Yes” for rehospitalization among 20 cases of all the check sample information in the check sample list 108. The ratio of rehospitalization is 1/20=0.05, namely 5%.

The check sample information (analysis sample information) displayed in the check sample list 108 in FIG. 16 is a result of selectively retrieving the judgment information and treatment result information in the record list 39 in relation to the period of “October 2014” and the place of “Tokyo”. The check sample information corresponds to the statistical information in the selectively retrieved form with selection queries. Also, the ratio of approval and the ratio of rehospitalization in the ratio display area 109 correspond to the statistical information. Note that the sample display area 98 can have a function of displaying a result of search of plural data of the check sample information according to plural Boolean search expressions in a changeable form with display areas of tabs or the like.

In FIG. 17, a storage medium 50A in the center server 11 stores control programs 115 as application programs. The control programs 115 are run to function the computer for the center server 11 as an information collection server apparatus and an information collection apparatus.

A CPU 52A (central processing unit) is incorporated in the center server 11. A memory 51A (not shown) cooperates with the CPU 52A upon starting up the control programs 115. Various circuit elements become active in the CPU 52A by use of the control programs 115, including a program controller 116 or processing unit, a first information collector 117, a second information collector 118 and an information provider 119.

The program controller 116 stores the diagnosis support program 30 to the program database 35 after uploading from the vendor terminal apparatus 16. The program controller 116 newly creates an area in the program list 38 for the diagnosis support program 30, and updates the program list 38 by inputting information to plural items in the program list 38. Also, the program controller 116 reads out the diagnosis support program 30 from the program database 35 according to a request of downloading from the facility terminal apparatus 13, and then transmits the diagnosis support program 30 to the facility terminal apparatus 13.

The first and second information collectors 117 and 118 operate for first and second collecting functions to collect the judgment information 26 and the treatment result information 28 from the facility terminal apparatus 13 in the hospital facility 12. In the embodiment, the judgment information 26 and the treatment result information 28 is automatically transmitted per each day from the facility terminal apparatus 13. The first and second information collectors 117 and 118 only retrieve the judgment information 26 and the treatment result information 28 transmitted per each day. In the present embodiment, the log file 65 and the treatment progress data of the electronic chart 22 of the patient body are collected. The log file 65 includes the input history information as the judgment information 26. The treatment progress data includes information of occurrence or non-occurrence of rehospitalization as the treatment result information 28. The first and second information collectors 117 and 118 register the judgment information 26 and the treatment result information 28 to the record list 39 in the record information database 36, to update the record list 39.

The information provider 119 provides the check sample information in response to the request for information from the vendor terminal apparatus 16 by use of the check sample page 92.

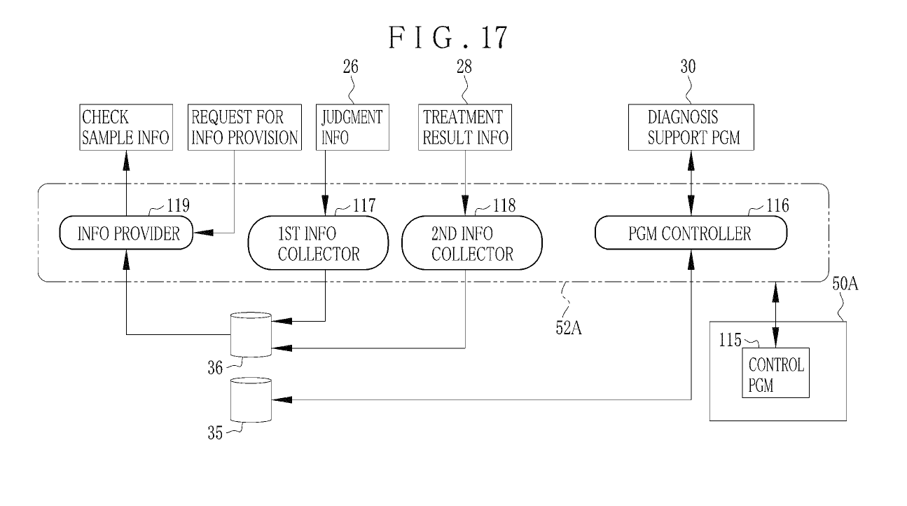

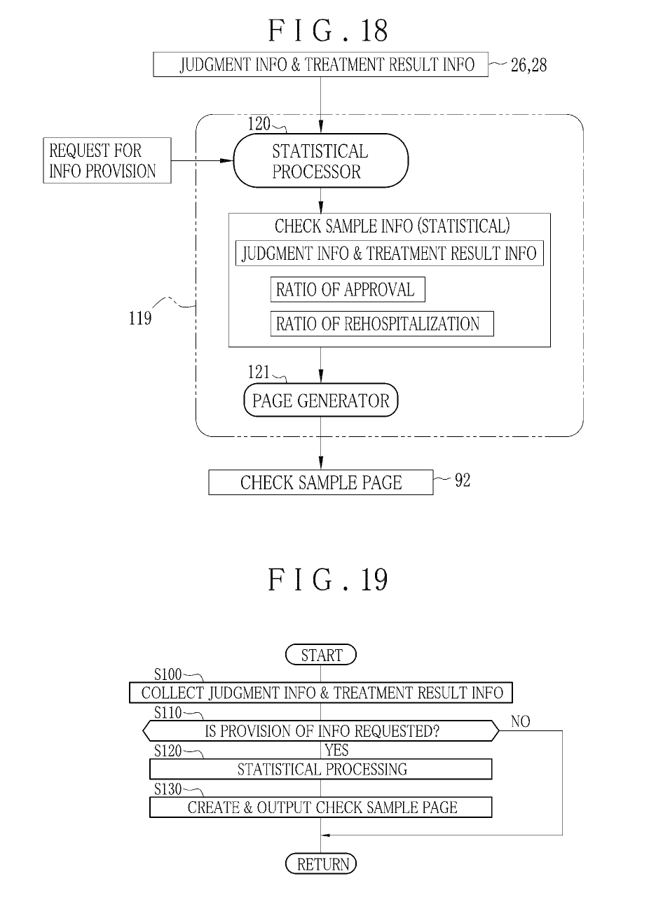

In FIG. 18, the information provider 119 includes a statistical processor 120 and a page generator 121. The statistical processor 120 performs statistical processing to the judgment information and treatment result information, and outputs statistical information as the check sample information. Specifically, the statistical processor 120 reads (picks up) the judgment information and treatment result information from the record list 39 in association with the diagnosis support program 30, the selection queries, and search query which are selectively input by the program selection area 95 and the search query area 97 in the check sample page 92. The statistical processor 120 transfers the judgment information and treatment result information to the page generator 121 as the check sample information.

In case the “Diagnosis Support Program A” is selected in the pull down menu 99 in FIG. 16, the statistical processor 120 reads (picks up) judgment information and treatment result information from the record list 39, the judgment information and treatment result information having the program ID of “PR1” of the Diagnosis Support Program A in the item of the program ID. In the example of FIG. 7, cases of this judgment information and treatment result information include a case of the facility ID of “HP1”, the date of use “2014.10.01” or “1 October 2014”, the case ID of “P1” and items of the first row, and a case of the facility ID of “HP1”, the date of use “2014.10.01” or “1 October 2014” and the case ID of “P2”, and a case of the date of use “2014.10.20” or “20 October 2014” and the case ID of “P10”. Assuming that “Tokyo” is input as a place in FIG. 16, then judgment information and treatment result information is read from the record list 39 with a facility ID of the hospital facility 12 of which “Tokyo” is registered in the item of a place in the facility list 40.

The statistical processor 120 calculates a ratio of approval and a ratio of rehospitalization according to the number of cases of the judgment information and treatment result information being read. The statistical processor 120 transfers the calculated ratios to the page generator 121 as check sample information (analysis sample information). Note that a ratio of non-approval can be used instead of the ratio of approval by referring to the information of “No” in the judgment field in the received judgment information and treatment result information. Also, a ratio of the complete cure can be used instead of the ratio of rehospitalization by referring to the information of “No” in the rehospitalization field in the received judgment information and treatment result information.

The page generator 121 creates the check sample page 92. To create the check sample page 92, the page generator 121 receives and considers the judgment information and treatment result information, the ratio of approval, and the ratio of rehospitalization from the statistical processor 120. A communication interface 53A (not shown) is used for the page generator 121 to output the check sample page 92 to the vendor terminal apparatus 16.

The operation of the above construction is described now. As illustrated in the flow of FIG. 19, the control programs 115 are run in the center server 11. The program controller 116, the first and second information collectors 117 and 118 and the information provider 119 are established in the CPU 52A. The computer constituting the center server 11 functions as the information collection server apparatus and the information collection apparatus.

In case the diagnosis support program 30 is uploaded by the vendor terminal apparatus 16, the program controller 116 writes the diagnosis support program 30 to the program database 35. In case a request from the facility terminal apparatus 13 is generated for downloading the diagnosis support program 30, the program controller 116 reads out the diagnosis support program 30 from the program database 35 according to the request, to distribute the diagnosis support program 30 to the facility terminal apparatus 13.

In case the patient health page 70 is displayed on the display panel 54B in the facility terminal apparatus 13 and the diagnosis support program 30 is used with the patient health page 70, the log file 65 is written to the storage medium 50B by the program controller 63. Medical events of the patient body are recorded to the treatment progress data in the electronic chart 22, including the hospitalization, surgery, check-out, rehospitalization and drug administration. The data uploader 64 uploads the log file 65 and the treatment progress data to the center server 11 through the communication interface 53B per each day, the log file 65 including the input history information as judgment information, the treatment progress data including occurrence or non-occurrence of rehospitalization as treatment result information.

In FIG. 19, the first and second information collectors 117 and 118 collect the judgment information and treatment result information from the facility terminal apparatus 13 in a step S100. The collected judgment information and treatment result information is registered in the record list 39 in the record information database 36 by the first and second information collectors 117 and 118.

A program developer (programmer) or programming staff at the vendor 15 performs access to the database web site for on-line access in the data center 10 by use of the vendor terminal apparatus 16, and receives authorization. After this, the initial page of the check sample page 92 is transmitted from the center server 11 to the vendor terminal apparatus 16 and displayed on the display panel 54C of the vendor terminal apparatus 16.

The program developer (programmer) or programming staff of the vendor 15 selectively inputs the diagnosis support program 30 or a search query as desired in the check sample page 92, and clicks the search button 101. Thus, the vendor terminal apparatus 16 transmits a request of information to the center server 11.

Upon receiving a request of information provision from the vendor terminal apparatus 16 (yes in a step S110), the statistical processor 120 in the center server 11 performs statistical processing in a step S120 according to the search query and the diagnosis support program 30 selectively input by the check sample page 92. The page generator 121 creates the check sample page according to the ratio of approval and the ratio of rehospitalization from the statistical processor 120 and the result information read (picked up) by the statistical processor 120. The check sample page 92 is output to the vendor terminal apparatus 16 by the communication interface 53A in a step S130.

The check sample page 92 is displayed on the display panel 54C of the vendor terminal apparatus 16 for the program developer (programmer) of the vendor 15 to view. He or she can monitor the diagnosis support program 30 for performance monitoring, and recognize the extent of contribution of the diagnosis support program 30 to the improvement of the treatment result by viewing the check sample page 92.

Specifically, assuming that the item of approval or non-approval in the check sample list 108 is “Yes” and assuming that the item of occurrence or non-occurrence of rehospitalization is “No”, then it is judged that the diagnosis support information output by the diagnosis support program 30 contributes successfully to improvement of the treatment results. In contrast, assuming that the item of approval or non-approval in the check sample list 108 is “Yes” and assuming that the item of occurrence or non-occurrence of rehospitalization is “Yes”, then it is judged that the diagnosis support information output by the diagnosis support program 30 does not contribute to improvement of the treatment results.

It is easily possible to perform the quality check and performance monitoring of the diagnosis support program 30 by considering the ratio of approval and the ratio of rehospitalization in the ratio display area 109, to find the degree of contribution of the diagnosis support information to the improvement of the treatment result. For example, in case the ratio of approval is as high as 90% and the ratio of rehospitalization is as low as 5% in FIG. 16, then the number of the patient bodies with improvement of the treatment results is high after the use of the diagnosis support information. The degree of contribution of the diagnosis support information to the improvement of the treatment result is found high. Assuming that both of the ratio of approval and the ratio of rehospitalization are comparatively high, the degree of contribution of the diagnosis support information to the improvement of the treatment result is found low, namely, the diagnosis support information has caused a decrease in the treatment result. Assuming that both of the ratio of approval and the ratio of rehospitalization are comparatively low, the degree of contribution of the diagnosis support information to the improvement of the treatment result is found low.

Also, the hospital facility 12 performs the selective retrieval (classification) to retrieve the judgment information and treatment result information for each of selection queries, so as to provide check sample information (analysis sample information) of reflecting intention of the program developer (programmer) or programming staff at the vendor 15. Assuming that the ratio of the approval is relatively low as a result of the selective retrieval with the selection query “Symptom”, then it is found that the diagnosis support program 30 for the same symptom can be improved. Assuming that the ratio of the approval is relatively low as a result of the selective retrieval with the selection query “Place”, then it is found that possibility of marketing of the diagnosis support program 30 for the same place is high. It is concluded that the selective retrieval is helpful for the purpose of commercial marketing in relation to necessity of improvement in the diagnosis support program 30 for a certain symptom, and possibility in sales of the diagnosis support program 30 for a certain place.

Also, the diagnosis support program 30 with high degree of contribution to improving the treatment result with a finding of the performance monitoring can be utilized as a model for modifying the diagnosis support program 30 having low degree of contribution to improving the treatment result, and for newly developing the diagnosis support program 30.

In the first embodiment, the data uploader 64 is established in the CPU 52B in the facility terminal apparatus 13, which automatically transmits the judgment information and treatment result information. However, the center server 11 can transmit a request to the facility terminal apparatus 13 for an output of the judgment information and treatment result information, so that the facility terminal apparatus 13 can transmit the judgment information and treatment result information to the center server 11 in response to the request.

### Second Embodiment

For developing the diagnosis support program 30, the vendor 15 is supplied with information including patient health data from the hospital facility 12, and constructs a processing algorithm for determining diagnosis support information to be output according to input data after evaluating the supplied information. The processing algorithm is an element important for development of the diagnosis support program 30 with high quality to contribute to improving treatment results. In a second embodiment, clinical data are collected as source information for outputting the diagnosis support information as assistance for constructing the processing algorithm, to encourage the development of the diagnosis support program 30 with high quality.

In the present embodiment, the program controller 63 established in the CPU 52B of the facility terminal apparatus 13 records clinical data to the log file 65 in addition to the calendar date, case ID, program ID, particular symptom, diagnosis support information and input history information according to the first embodiment. The data uploader 64 uploads the log file 65 including the clinical data to the center server 11 through the communication interface 53B.

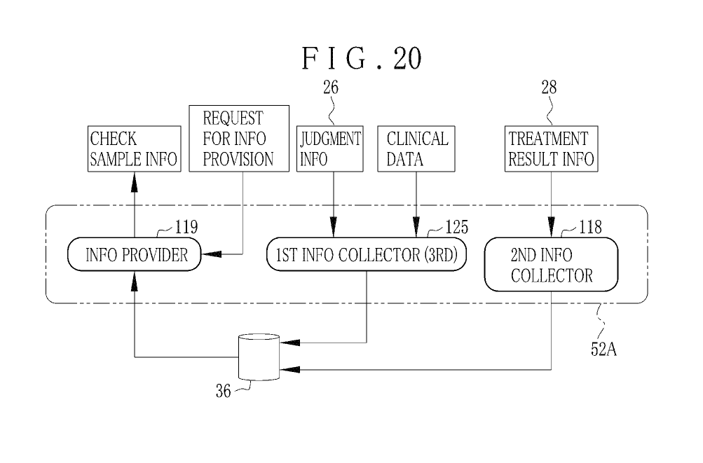

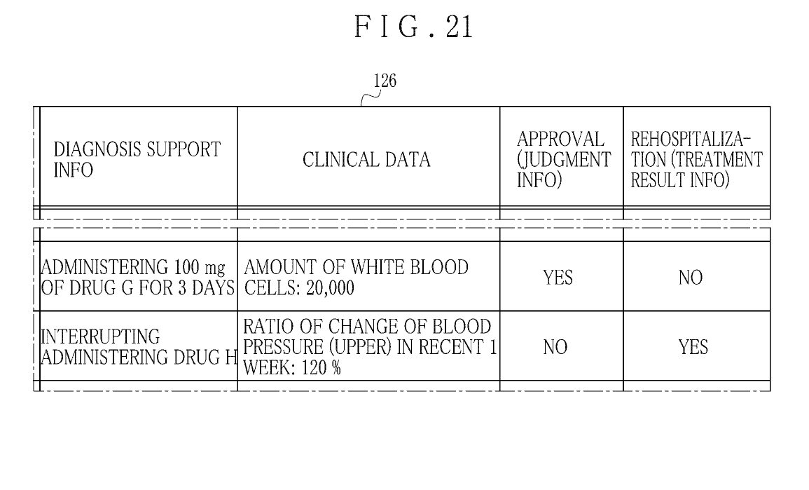

In FIG. 20, a first information collector 125 collects the judgment information 26 in the same manner as the first information collector 117 of the first embodiment, and also collects clinical data. In short, the first information collector 125 is functioned also as a third information collector. The clinical data collected by the first information collector 125 are registered in a record list 126 for judgment and treatment results, together with the judgment information 26 and the treatment result information 28. See FIG. 21. In FIG. 20, the judgment information 26 and clinical data are depicted discretely. However, the judgment information and clinical data are actually collected in the first information collector 125 in the form of the log file 65. In FIG. 20, the program controller 116 is not shown.

In FIG. 21, items of clinical data are provided in the record list 126 in addition to the items of the record list 39 of the first embodiment. As depicted in the drawing, a processing algorithm is “Output information of administering 100 mg of Drug G for 3 days as diagnosis support information assuming that the amount of white blood cells is 10,000-50,000”. The amount of white blood cells of the patient body is 20,000. Then the clinical data is 20,000 of the amount of white blood cells. Furthermore, a processing algorithm can be “Output information of interrupting administration of Drug H as diagnosis support information assuming that a ratio of a change in the upper value of the blood pressure of the input data is 100-150% in recent one week”. The ratio of the change in the upper value of the blood pressure of the input data is 120% in recent one week”. Then the clinical data is 120% for the ratio of the change in the upper value of the blood pressure of the input data is 120% in recent one week”.

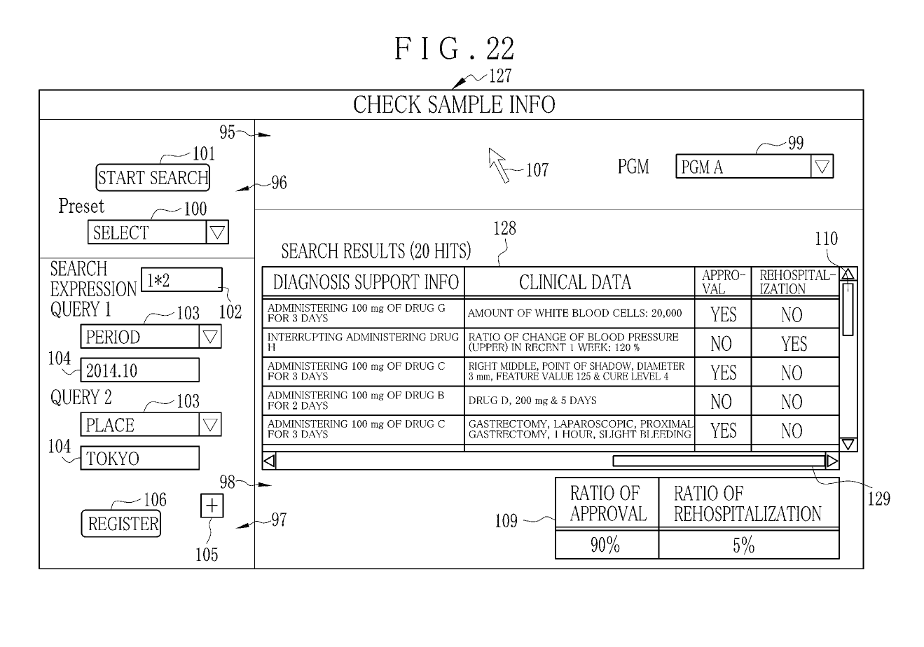

The statistical processor 120 in the information provider 119 also processes the clinical data for statistical processing of selective retrieval or the like in the same manner as the judgment information and treatment result information. In FIG. 22, a check sample page 127 or analysis sample page is created by the page generator 121. The check sample page 127 has a check sample list 128 or analysis sample list, which includes a portion of the check sample list 108 of the first embodiment and additionally items of the clinical data. A scroll bar 129 is disposed to scroll the check sample list 128 horizontally. It is possible to display undisplayed items in FIG. 22, such as facility names and dates of use, by operating the scroll bar 129.

Providing the check sample information (analysis sample information) inclusive of clinical data in addition to the judgment information and treatment result information makes it possible to recognize a relationship between the clinical data and the approval and non-approval, so that performance monitoring of the diagnosis support program 30 is possible. Development of the diagnosis support program 30 can be encouraged with high quality for contribution in increasing the treatment result.

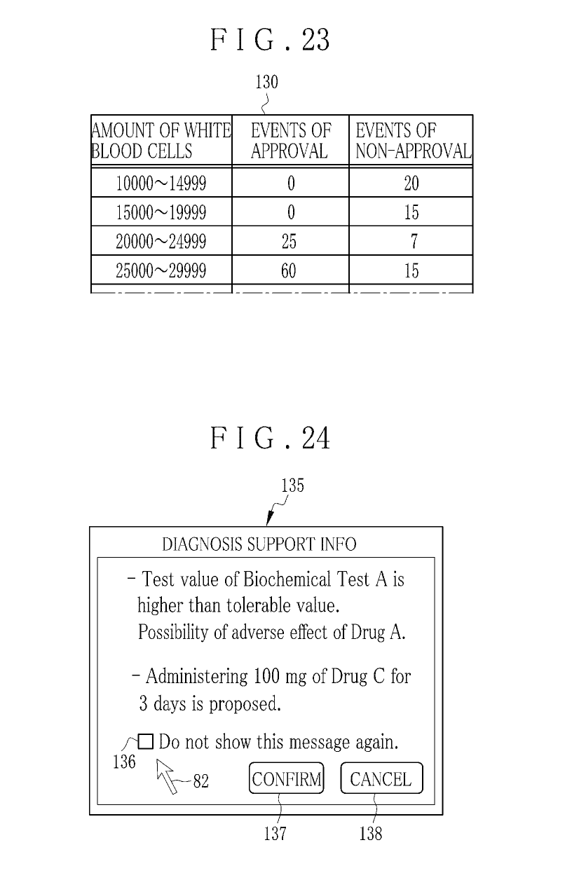

Furthermore, a data table 130 in FIG. 23 can be output as statistical information or sample information after statistical processing of judgment information and clinical data in the statistical processor 120, so that the data table 130 can be provided as check sample information.

The data table 130 indicates the number of times of approval and non-approval for respective ranges of the amount of white blood cells as clinical data on the condition of a processing algorithm of “outputting diagnosis support information of administering 100 mg of Drug G for 3 days in case the amount of the white blood cells of the input data is 10,000-50,000”. It is possible to propose optimization of the processing algorithm to the vendor 15 by providing the data table 130 as check sample information (analysis sample information).

Specifically, the number of approval in the respective ranges “10,000-14,999” and “15,000-19,999” for the amounts of white blood cells in the data table 130 is “Zero”. A change in the processing algorithm from the item “10,000-50,000 for the amount of the white blood cells as input data” to the item “20,000-50,000 for the amount of the white blood cells as input data” can be preferably suggested to a program developer (programmer) or programming staff at the vendor 15. Note that a histogram can be created in place of the data table 130 and output as statistical information. The histogram can have a horizontal axis on which a range of the clinical data is taken, and a vertical axis on which the number of times of approval or non-approval is taken.

The examples of the clinical data in the above embodiment are a measured value of examination and vital sign, such as an amount of white blood cells and a change ratio of an upper value of a blood pressure in recent one week. Further examples of the clinical data can be a type, size, feature value, cure level and the like of a lesion (symptom), and a type, dose, period of administration of a drug, and the like, in relation to examination of a patient body among patient health data. In FIG. 22, data related to the lesion are “right middle, upper point of shadow, diameter 3 mm, feature value 125 and cure level 4” in the third row in the check sample list 128. In FIG. 22, data related to the drug are “Drug D, 200 mg and 5 days” in the fourth row in the check sample list 128. Also, examples of clinical data can be surgery-related information related to surgical operation of the patient body among the patient health data, such as a surgical procedure, incision method, surgical time, and blood loss (blood volume of bleeding). Examples of the incision method are open abdominal surgery, laparoscopic, partial incision, full incision, amount of margin of incision and the like. In FIG. 22, the surgery-related information is “gastrectomy, laparoscopic, proximal gastrectomy, 1 hour, slight bleeding” in the fifth row in the check sample list 128.

Examples of clinical data for the diagnosis support program 30 can be a type, dose, and period of administration of a drug, a test value of medical examination, measured values of vital signs and the like, for the purpose of the diagnosis support program 30 to detect adverse effect of the drug and treatment effect of the drug. Example of clinical data of the diagnosis support program 30 can be a type, feature value, location and cure level of a lesion (symptom), surgical procedure, incision method, surgical time, blood loss and the like, for the purpose of the diagnosis support program 30 to search similar symptoms.

In the first embodiment, the diagnosis support program 30 for use is selected in the pull down menu 80 in the diagnosis support area 76 of the patient health page 70. Calculation with the diagnosis support program 30 is performed by selecting the process button 81. However, one of the diagnosis support programs 30 can be automatically selected as a representative program and calculation can be formed by the program. To this end, the representative diagnosis support program can be predetermined for each of the symptoms (diseases and the like). This is effective in reducing laborious manipulation of selecting the diagnosis support programs 30 or selecting the process button 81. Furthermore, the representative program can be predetermined for particular medical events in the course of treatment in a treatment plan. For example, the diagnosis support program 30 can be for the purpose of detecting occurrence of adverse effect of a drug. In case the drug administration of a first predetermined period (course) is ended and in case the drug administration of a second predetermined period (course) is started according to the treatment plan, then arithmetic operation with the diagnosis support program 30 can be automatically performed.

In the first embodiment, the OK button 85 and the cancel button 86 are used to approve or cancel in relation to the diagnosis support area 76. However, a display form of diagnosis support information and inputs of approval and non-approval are not limited to the embodiment. For example, a diagnosis support window 135 with diagnosis support information for supporting diagnosis of FIG. 24 can be displayed in the patient health page 70 in a pop-up form automatically to perform the arithmetic operation in the representative diagnosis support program 30.

In FIG. 24, various data of the diagnosis support information are displayed in the diagnosis support window 135 in the same manner as FIG. 13, including a finding related to a test value of the “Biochemical Test A”, and comment for proposing the use of “Drug C” alternative to “Drugs A and B”. Also, the diagnosis support window 135 includes a check box 136, a confirm button 137 and a cancel button 138. A phrase of “Do not show this message again” is associated with the check box 136.

In case the confirm button 137 is clicked irrespective of selection of the check box 136, a request for administration of “Administering 100 mg of Drug C for 3 days” is performed automatically in the same manner as clicking the OK button 85 in the first embodiment. Patient health data in the item of drug administration of the electronic chart 22 of the patient body is updated automatically. The program controller 63 records “Approval” for the input history information of the log file 65.

Assuming that the confirm button 137 is clicked while the check box 136 is selected, the diagnosis support program 30 of the representative form performs a start of arithmetic operation. However, the diagnosis support window 135 is not displayed. Data of “Non-approval” is recorded to the input history information of the log file 65 by the program controller 63.

In case the cancel button 138 is clicked irrespective of selection in the check box 136, then the program controller 63 records “Non-approval” for the input history information in the log file 65 in the same manner as clicking the cancel button 86 in the first embodiment. Thus, approval and non-approval can be judged by considering a status of the selection of the check box 136 in addition to clicking the button.

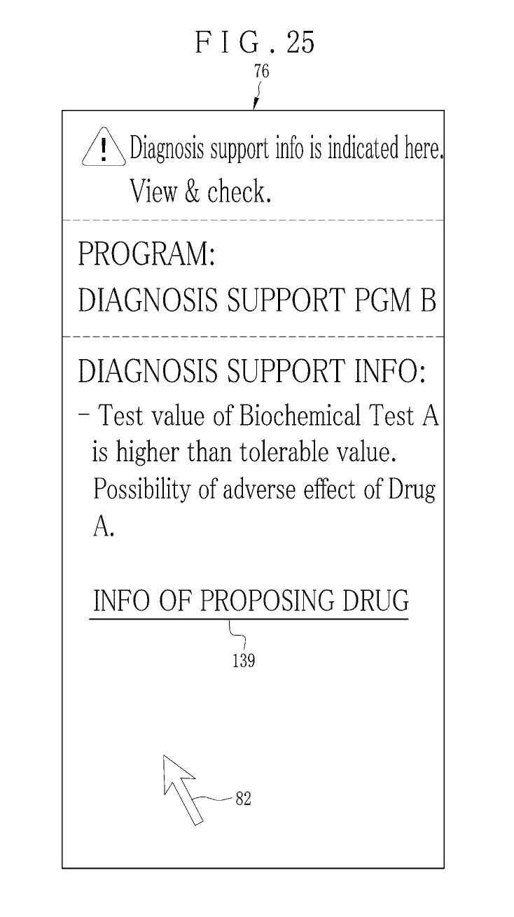

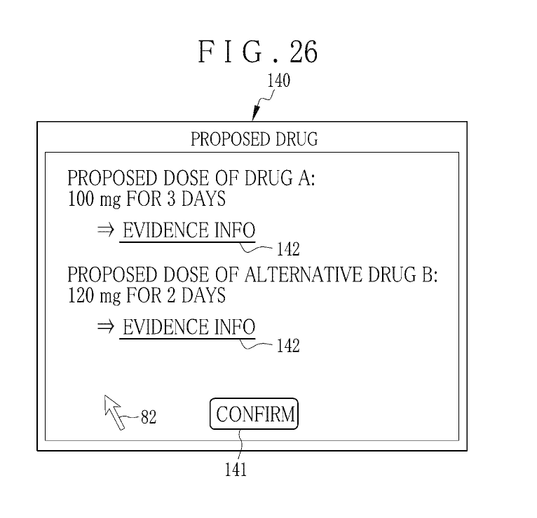

It is also possible in FIG. 25 to create link information 139 in the diagnosis support area 76 for notifying information of proposing a drug. A proposed drug window 140 of FIG. 26 becomes displayed on the patient health page 70 in a pop-up form in response to clicking of the link information 139.

In FIG. 26, the diagnosis support information is displayed in the proposed drug window 140, including a proposed dose and administration period of “Drug A”, and a proposed dose and administration period of “Drug B” alternative to “Drug A”. The proposed drug window 140 has a confirm button 141 and evidence link information 142. The confirm button 141 is used for deleting the proposed drug window 140 displayed in the pop-up form. The evidence link information 142 is associated with evidence data for contribution of the displayed diagnosis support information to improving the treatment result. In case the evidence link information 142 is clicked, a page (not shown) for the evidence data is displayed in the proposed drug window 140 in a pop-up form.

The evidenced data is a document, thesis or the like with description of a progress of measured values of the vital signs of a patient body of which a condition is improved by using the treatment plan following the suggestion of the diagnosis support information even with the same symptom as the particular patient body, and description of an improvement in the condition after using the treatment plan following the suggestion of the displayed diagnosis support information.

In case the evidence link information 142 for the evidence data is clicked in the proposed drug window 140, “Approval” is recorded for the input history information of the log file 65. Also, it is possible to record “Approval” for the input history information of the log file 65 in case the link information 139 for notifying information of proposing a drug is clicked in the diagnosis support area 76.

Assuming that there is no clicking of the link information 139 in the diagnosis support area 76, or assuming that the confirm button 141 is clicked in the proposed drug window 140 without clicking the evidence link information 142 to the evidence data, then “Non-approval” is recorded as input history information in the log file 65. Thus, it is possible to determine approval and non-approval according to occurrence of an input of referring to information, such as clicking the link information 139 or 142.

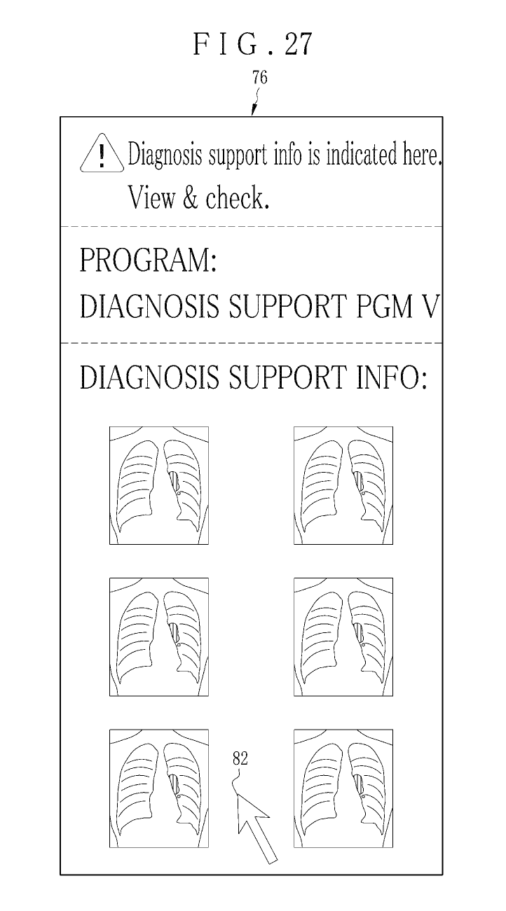

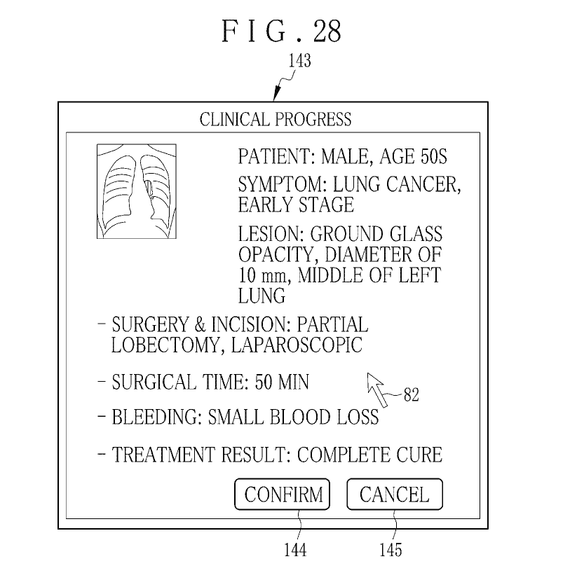

In FIGS. 27 and 28, a display form of the diagnosis support information is illustrated in the use of the diagnosis support program 30 for searching similar symptoms. The diagnosis support program 30 is supplied with input data of patient health data, which include a symptom of the patient body, and location, size and type of a lesion (symptom) of the patient body in the diagnostic image 23. The diagnosis support program 30 searches the diagnostic images 23 of past patient bodies from the image database 21, the past patient bodies being different from the patient body and having coincidence or similarity to the patient body in relation to a predetermined symptom, location, size, type and the like of a lesion and the like. The diagnosis support program 30 outputs the diagnostic images 23 being searched as diagnosis support information. Also, the diagnosis support program 30 retrieves various data from the treatment progress data in the diagnostic image 23 for the patient of the diagnostic image 23, and outputs the various data as diagnosis support information, the various data including data of a surgical procedure, incision method, surgical time, blood loss, and a result of the surgery (complete cure, further surgery, rehospitalization, death and the like).

In FIG. 27, the diagnosis support area 76 displays thumbnail images of the diagnostic images 23 read from the image database 21 in a list form as diagnosis support information. Upon clicking one of the thumbnail images, a clinical progress window 143 of FIG. 28 becomes displayed on the patient health page 70 in a pop-up form.

In FIG. 28, the clinical progress window 143 displays various data of the diagnosis support information together with the thumbnail image of the diagnostic image 23 clicked in the diagnosis support area 76, the various data including information of a patient body, symptom, and type, size and location of a lesion (symptom), and a surgical procedure, incision method, surgical time, blood loss and treatment result. Also, a confirm button 144 and a cancel button 145 are disposed in the clinical progress window 143.

Assuming that the confirm button 144 is clicked in the clinical progress window 143 or assuming that the thumbnail image is clicked in the diagnosis support area 76, “Approval” is recorded as input history information of the log file 65. It is possible automatically to request surgical operation of an indicated surgical procedure and incision method upon clicking the confirm button 144 in the clinical progress window 143.

Assuming that no click is made at the thumbnail image in the diagnosis support area 76 or assuming that the cancel button 145 is clicked in the clinical progress window 143, then “Non-approval” is recorded for the input history information in the log file 65. Approval and non-approval can be judged according to a status of selection of a thumbnail image or other data.

In the above embodiment, a request can be generated in the patient health page 70, for example, request for drug administration upon selection of the OK button 85. This request is performed normally on an request generation page of the electronic chart 22. In consideration of this, it is possible to dispose link information for reading out the request generation page for the electronic chart 22 in any one of the diagnosis support area 76 in FIG. 13, the diagnosis support window 135 in FIG. 24, the proposed drug window 140 in FIG. 26, and the clinical progress window 143 in FIG. 28. The request can be generated in the request generation page of the electronic chart 22.

### Third Embodiment

In the above embodiment, the OK button 85 in FIG. 13 is selected and “Approval” is recorded for the input history information of the log file 65 in the structure of generating a request in a request generation page distinct from the patient health page 70 to separate the judgment of the approval and non-approval from the generation of the request. However, a request generation page for the electronic chart 22 is likely to generate a request different from the request of “Administering 100 mg of Drug C for 3 days” suggested in the diagnosis support information. A problem of inconsistency occurs as “Approval” is registered in the judgment information in spite of the actual status of Non-approval. In view of this, a third embodiment is provided to eliminate inconsistency in relation to the approval.

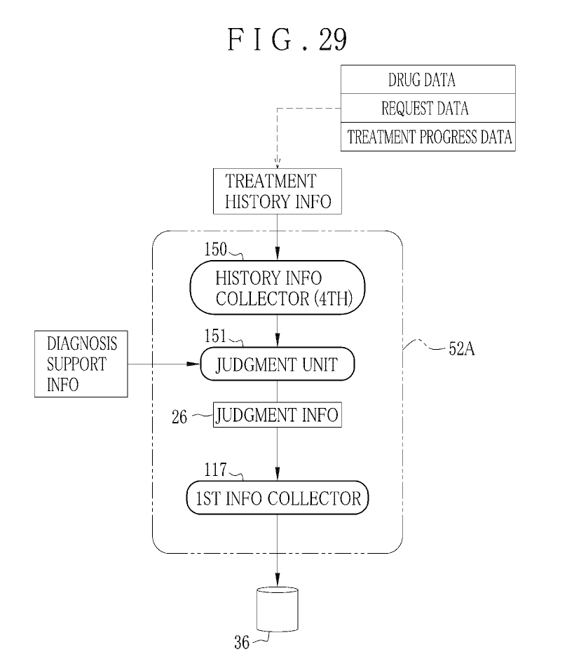

In FIG. 29, a history information collector 150 (fourth) and a judgment unit 151 or judgment device are established in the CPU 52A of the center server 11 in addition to the circuit elements in the CPU 52A of the first embodiment. Only the first information collector 117 among those is illustrated in FIG. 29. The history information collector 150 collects treatment history information of history of treatment to the patient body among his or her patient health data. The treatment history information is included in the patient health data in the electronic chart 22 of the patient body, and specifically includes drug administration data of a date and dose of the drug administration, request data for requesting medical examination, treatment, surgery, drug administration and the like, and treatment progress data. The treatment history information is periodically output (uploaded) by the data uploader 64 in the same manner as the judgment information 26 and the treatment result information 28 of the first embodiment.

The history information collector 150 transfers the collected treatment history information to the judgment unit 151.

The judgment unit 151 compares the diagnosis support information from the diagnosis support program 30 with the treatment history information, and checks whether a treatment plan following the suggestion of the diagnosis support information is approved or not. The judgment unit 151 transmits the judgment information 26 from a result related to the approval to the first information collector 117.

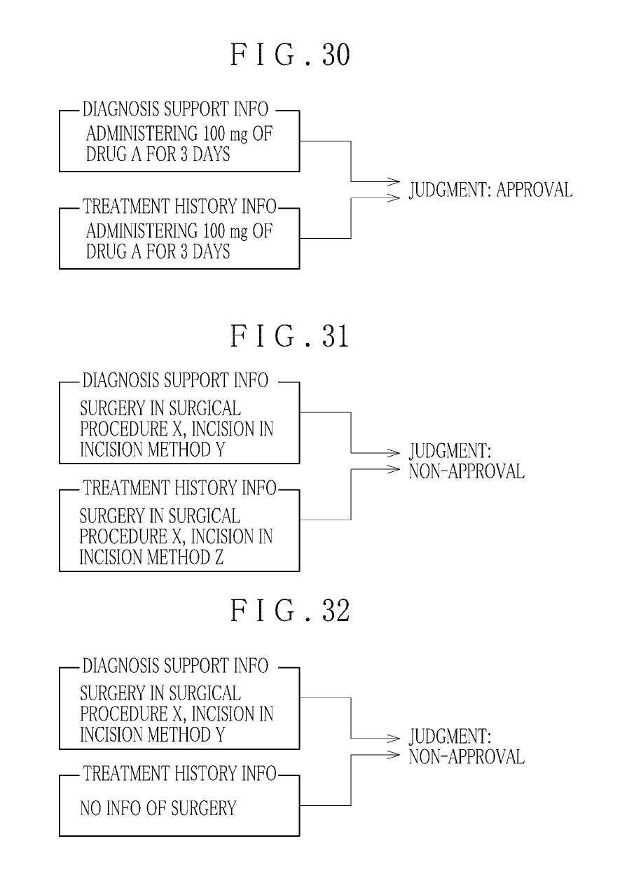

Specifically, the judgment unit 151 judges that the treatment plan according to the suggestion of the diagnosis support information (result: approval) upon finding coincidence between the diagnosis support information and treatment history information as “Administering 100 mg of Drug A for 3 days”. See FIG. 30.

In FIG. 31, the diagnosis support information includes information of “Surgical Procedure X and Incision Method Y”. The treatment history information includes information of “Surgical Procedure X and Incision Method Z”, so that there is a difference in the incision method. Then the judgment unit 151 generates a judgment result of non-approval by judging that there is no utilization of a treatment plan based on the suggestion of the diagnosis support information.

Assuming that there is no information related to surgery corresponding to the treatment history information in contribution with diagnosis support information of the “surgery of the Surgical Procedure X and Incision Method Y” as illustrated in FIG. 32, the judgment unit 151 judges that the treatment plan based on the suggestion of the diagnosis support information is not approved (Non-approval after the judgment). Thus, the approval and non-approval is judged by comparison of the diagnosis support information with the treatment history information. A result of the approval and non-approval can be kept consistent with the approval and non-approval registered in the judgment information.

In FIG. 30, exact coincidence between the diagnosis support information and treatment history information is checked for the judgment. However, a criterion for the judgment related to the approval can be coincidence with a small predetermined difference.

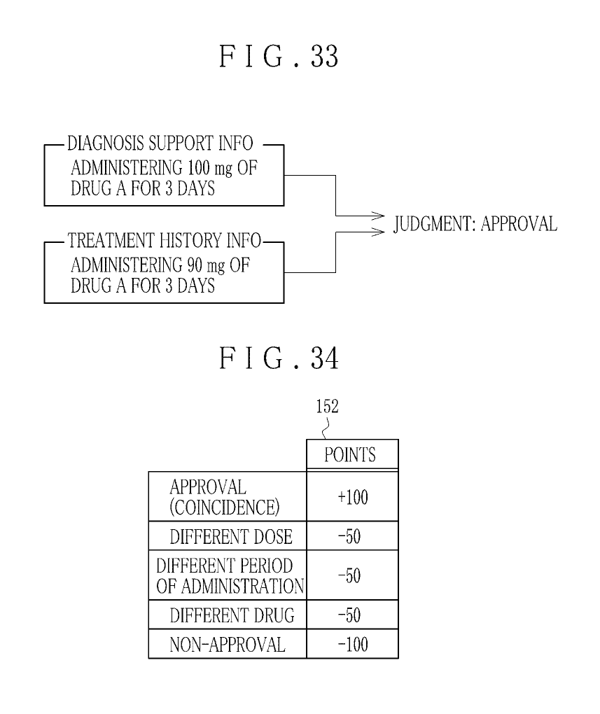

For example, a dose of Drug A for a criterion of judgment can be 100 plus or minus 10 mg. In FIG. 33, the diagnosis support information is “Administering 100 mg of Drug A for 3 days”. The treatment history information is “Administering 90 mg of Drug A for 3 days”. Then it is judged that there is utilization of a treatment plan based on the suggestion of the diagnosis support information.

Furthermore, grades of the approval and non-approval can be represented by values of points in place of only the two options of the approval and non-approval. In FIG. 34, a point table 152 for evaluation is illustrated. Points of “+100” are provided assuming that a treatment plan based on a suggestion in the diagnosis support information is adapted, namely in the case of exact coincidence between the dose, period of administration and type of a drug according to the diagnosis support information and the dose, period of administration and type of the drug in the treatment history information. Points of “−100” are provided in the case of non-approval, namely assuming that a treatment plan based on a suggestion in the diagnosis support information is not used due to the lack of treatment history information as illustrated in FIG. 32. “Reduction of 50 points” is provided assuming that there is at least one item with a difference from the diagnosis support information among the items including the dose, period of administration, and type of the drug in the treatment history information. In short, “+50” points are provided assuming that only the dose is different. “0” point is provided assuming that the dose and period of administration are different. “−50” points are provided assuming that differences occur for all of the dose, period of administration and type of the drug.

For the item of the judgment information in the record list 39, points of “+100”, “−50” and the like are registered in place of “Approval” and “Non-approval” in the first embodiment. The statistical processor 120 adds up the points of the item of the judgment information in the group of the judgment information and treatment result information retrieved (picked up) by the selective retrieval, divides the added value by the number of the cases of the retrieved judgment information and treatment result information, and outputs a result of the division as the ratio of approval. Note that the point table 152 in FIG. 34 is only an example. It is possible to allocate 100 points to the approval and 0 point to the non-approval. Points can be subtracted suitably in the case of a difference in the dose of the drug, and administration period and the type of the drug.

For the diagnosis support program 30 to search similar symptoms in FIGS. 27 and 28, a treatment result of the symptom information where the confirm button 144 is clicked in the clinical progress window 143 is compared with the treatment result of the patient body by the judgment unit 151. Assuming that coincidence between the treatment results occurs, approval can be judged. Assuming that lack of coincidence between the treatment results occurs, non-approval can be judged.

### Fourth Embodiment

Assuming that the diagnosis support information is different from the treatment history information and assuming that the judgment unit 151 judges the non-approval, then the treatment history information is information of aid for constructing a processing algorithm in the same manner as clinical data in the second embodiment. Thus, the treatment history information is provided as check sample information in the case of non-approval according to the judgment unit 151.

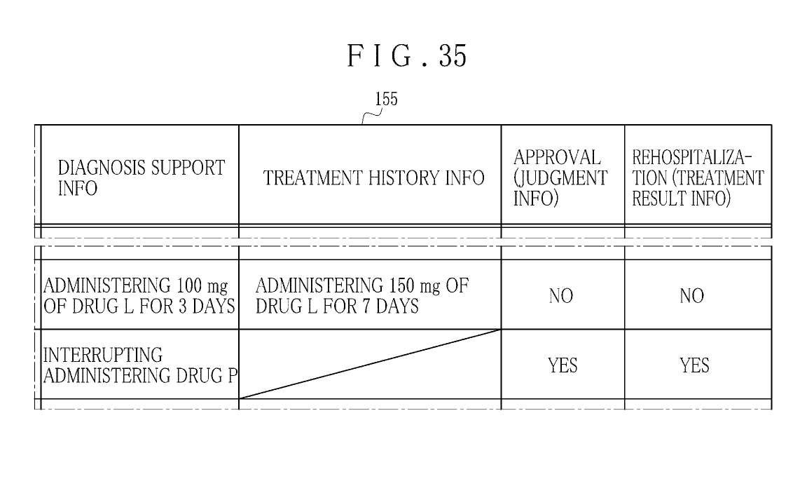

In FIG. 35, a record list 155 as history information for judgment and treatment results of the embodiment includes an item of treatment history information in addition to the various items of the record list 39 in the first embodiment. The item of the treatment history information is registered only at the time of “non-approval” after the judgment. In FIG. 35, the diagnosis support information is information of “Administering 100 mg of Drug L for 3 days”. The treatment history information is information of “Administering 150 mg of Drug L for 7 days”. A result of judgment in the judgment unit 151 is non-approval.

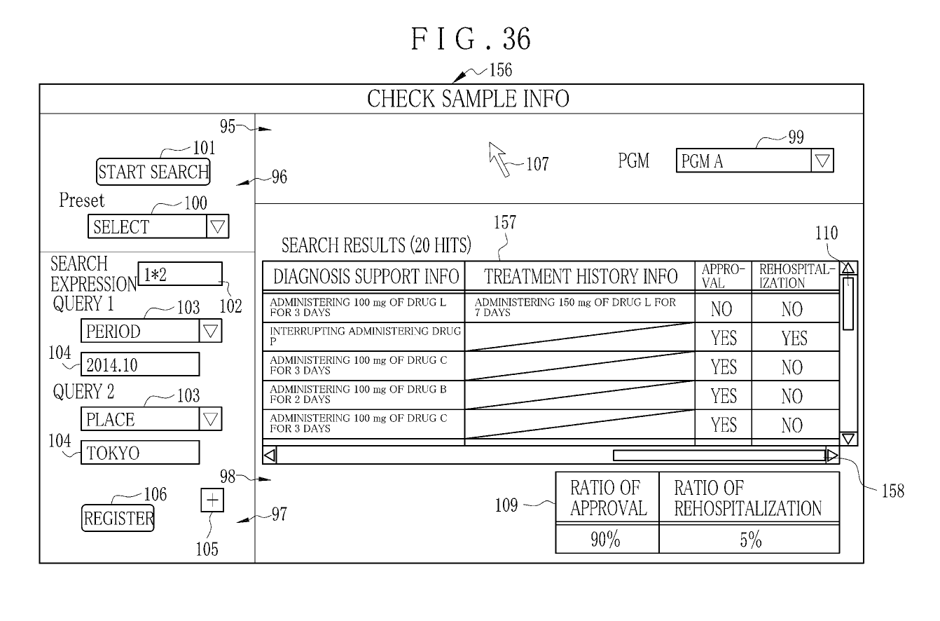

The statistical processor 120 processes the treatment history information in the statistical processing of selective retrieval in the same manner as the judgment information and treatment result information. In FIG. 36, a check sample page 156 or analysis sample page is created by the page generator 121. A check sample list 157 or analysis sample list is provided in the check sample page 156, and has a form including the check sample list 108 of the first embodiment and additionally the item of the treatment history information. A scroll bar 158 is used for horizontally scrolling the check sample list 157 in the same manner as the scroll bar 129 in FIG. 22.

Thus, providing the check sample information (analysis sample information) having the treatment history information in addition to the judgment information and the result information makes it possible to recognize a close relationship between actual history of the treatment with the treatment result. Development of the diagnosis support program 30 of a high quality can be enhanced for the purpose of improving the treatment result.

Specifically, while the treatment history information is displayed with the “No” for approval in the judgment and in the case of “No” for occurrence or non-occurrence of the rehospitalization, then it is found that a treatment plan according to the treatment history information contributes more highly to improving the treatment result than a treatment plan suggested in the diagnosis support information. The processing algorithm can be changed according to the treatment history information.

In the above embodiments, the treatment result information includes occurrence or non-occurrence of rehospitalization of the patient body. However, the invention is not limited to those embodiments. For example, treatment result information to be collected can be a cost of the hospitalization of the patient body, cure level of the lesion (symptom) of the patient body, and the like.

In FIG. 37, a record list 160 for judgment and treatment results includes the items of the record list 39 of the first embodiment and additionally items of the cost of hospitalization of the patient body and a change in the cure level of the lesion (symptom) of the patient body. The cost of hospitalization is extracted by the data uploader 64 in the facility terminal apparatus 13 from the information of the health care cost (reward) in the payment data in the electronic chart 22 of the patient body. The cure level of the lesion of the patient body is extracted by the data uploader 64 from the information of image analysis of the diagnostic image 23 of the patient body. The extracted information is uploaded to the center server 11. Assuming that there occurs improvement in the cure level at the time of patient care with the diagnosis support program 30 in comparison with a previous cure level, “Improved” is recorded in the item of the change of the cure level. Assuming that there occurs exacerbation in the cure level at the time of patient care with the diagnosis support program 30, “Exacerbated” is recorded in the item of the change of the cure level. Assuming that no change occurs in the cure level at the time of patient care with the diagnosis support program 30, “Unchanged” is recorded in the item of the change of the cure level.

For this situation, the statistical processor 120 calculates a ratio of an increase or decrease of the cost of the hospitalization of the patient body in comparison with a reference cost, and an improvement rate of a lesion of the patient body. See FIG. 38. The statistical processor 120 outputs those ratios as statistical information.

The expense ratio (ratio of an increase/decrease) is obtained by dividing the cost of hospitalization of the patient body by the reference cost. Let the cost of hospitalization be 300,000 yen. Let the reference cost be 500,000 yen. Then the expense ratio is 300,000/500,000=0.6, namely 60%. Should the expense ratio be more than 100%, the treatment results are good because the cost of hospitalization is higher than the reference cost. Should the expense ratio be less than 100%, the treatment results are poor because the cost of hospitalization is lower than the reference cost. An example of the reference cost is an average cost of hospitalization in hospital facilities in the same country, and is previously stored in the storage medium 50A for the lesion and the surgical procedure of the surgery.

The improvement rate is a ratio of cases with record of “improvement” in the item of the change in the cure level in the judgment information 26 and the treatment result information 28 retrieved in the selective retrieval. For example, the total number of cases of the judgment information 26 and the treatment result information 28 retrieved in the selective retrieval is 20. The number of cases of the “improvement” in the item of the change in the cure level is 15. Then the improvement rate is 15/20=0.75, namely 75%. It is possible to determine an exacerbation rate in place of the improvement rate, as a ratio of cases with record of “exacerbation” in the item of the change in the cure level in the judgment information 26 and the treatment result information 28 retrieved in the selective retrieval.

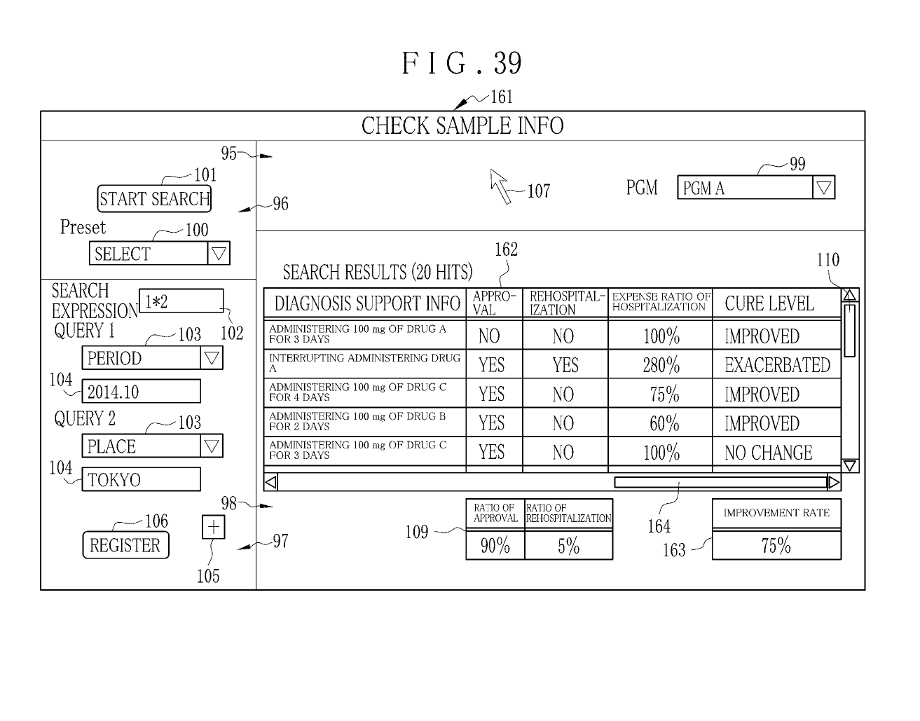

In FIG. 39, a check sample page 161 or analysis sample page is created by the page generator 121. The check sample page 161 includes a check sample list 162 or analysis sample list, and an improvement ratio area 163. The check sample list 162 is constituted by the check sample list 108 of the first embodiment and items of the expense ratio of the hospitalization and a change of the cure level. Note that a scroll bar 164 is used to scroll the check sample list 162 horizontally in the same manner as the scroll bars 129 and 158 in FIGS. 22 and 36.

Thus, the information of the cost of hospitalization of the patient body and the cure level of his or her symptom (lesion) is collected in addition to information of his or her rehospitalization. Check sample information (analysis sample information) is provided, inclusive of a ratio (expense ratio) of an increase or decrease of the cost of hospitalization from a reference cost, a change in the cure level of the symptom, and an improvement rate of the cure of the symptom. A plan of developing the diagnosis support program 30 can be determined by use of the more numerous factors or values.

In relation to the check sample list 162 in FIG. 39, the diagnosis support information is “Administering 100 mg of Drug C for 4 days” in the third row, and is “Administering 100 mg of Drug C for 3 days” in the fifth row. Check sample information of the third and fifth rows is “No” for occurrence and non-occurrence of rehospitalization. An expense ratio of the hospitalization is “75%” in the third row and “100%” in the fifth row. A change in the cure level is “Improvement” in the third row and “No change” in the fifth row. It is concluded that the treatment result is better in the third row. It is possible to refine sampling of the check sample information for the purpose of changing the processing algorithm, for example, to use the check sample information of the third row in place of the check sample information of the fifth row.

As described above, the treatment result information is occurrence or non-occurrence of rehospitalization of the patient body, cost of the hospitalization, and cure level of a lesion of the patient body. Further examples of the treatment result information can be information of the number of days of the hospitalization, a living or dead status of the patient body, progress of rehabilitation, and the like. The information of the number of days of the hospitalization can be a ratio of an increase or decrease (change ratio) of days in comparison with a reference number of days. The information of the living or dead status of the patient body can be a survival rate or a death rate.

### Fifth Embodiment

The selection queries for selectively retrieving the judgment information and treatment result information are the period, place of the hospital facility, particular symptom and the like in the first embodiment. However, a selection query in the fifth embodiment is data in attribute information of a patient body.

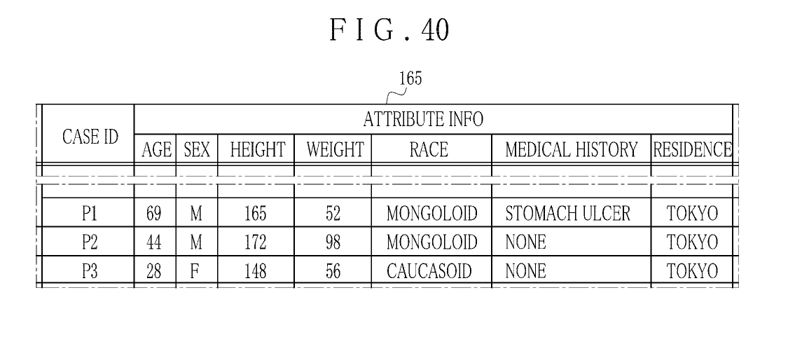

In FIG. 40, a record list 165 for judgment and treatment results includes items to constitute attribute information of the patient body. The items include an age, sex, height, weight, race (ethnicity), medical history, residence and the like. The attribute information is extracted by the data uploader 64 in the facility terminal apparatus 13 from description in the attribute information in the electronic chart 22 of the patient body, and then transmitted to the center server 11.

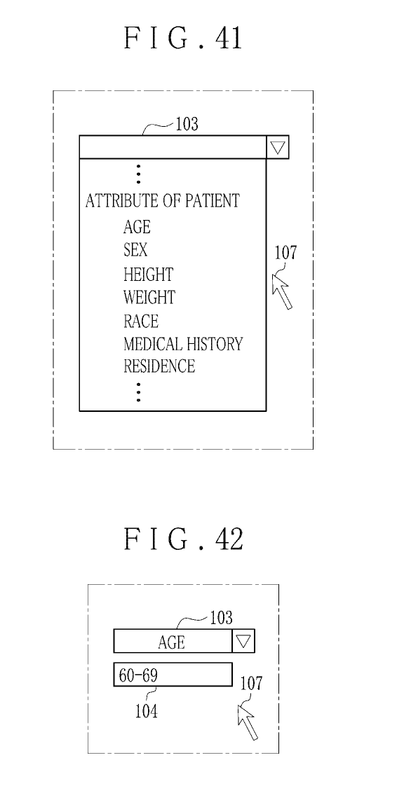

In FIG. 41, the pull down menu 103 of the search query area 97 in the check sample page displays selection options of items of the attribute information, such as the age, sex, height, weight, race, medical history and residence.

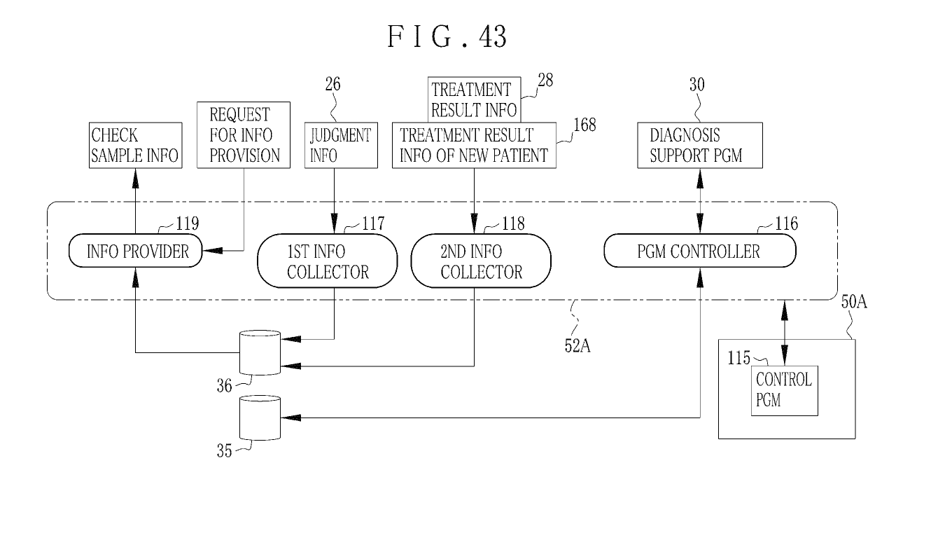

In FIG. 42, the age range is selected by use of the cursor 107. “60-69” as an expression of sixties for the age range is input to the search query box 104 before the search button 101 is clicked. Then the statistical processor 120 retrieves the judgment information and treatment result information from the record list 165 with the information of the age range “60-69” at the item of the age range in the attribute information. In the check sample list, check sample information of patient bodies with the age range of sixties is displayed.

Thus, the selective retrieval of the items of the attribute information of the patient body as selection queries makes it possible to perform the performance monitoring of the diagnosis support program 30, to discover the diagnosis support program 30 which does not contribute to improving the treatment result. Elements in the processing algorithm which should be improved according to the attribute of the patient body can be recognized.

In the above embodiments, the destination of providing the check sample information (analysis sample information) is only the vendors 15. However, the check sample information can be provided also to the hospital facility 12. It is possible in the hospital facility 12 to recognize a function and quality of the diagnosis support program 30 from the check sample information, to determine whether the diagnosis support program 30 should be introduced or not according to evaluating the function and the quality. The hospital facility 12 can make its own decision for introducing the diagnosis support program 30 in an irrespective manner of commercial marketing of the vendors 15.

To the vendors 15, the provision of the check sample information is also useful for commercial promotion of the diagnosis support program 30 to the hospital facility 12. Consequently, labor which has been used conventionally for promotion of the diagnosis support program 30 can be utilized now for the development of the diagnosis support program 30. As a result, the development of the diagnosis support program 30 can be enhanced reliably.

Furthermore, destination of supply of the check sample information is not limited to the hospital facility 12 or the vendors 15, and can be another client node (user), for example, a public organization of medicine, patient, or other facilities. To this end, the information provider 119 provides the check sample information according to a request of information from a personal computer or tablet terminal apparatus owned by the user or facilities.

### Sixth Embodiment

In the above embodiments, the second information collector 118 collects only the treatment result information 28 of the patient body associated with the diagnosis support program 30 for determining a treatment plan. However, the second information collector 118 in a sixth embodiment collects treatment result information of a new (second) patient body unrelated to the diagnosis support program 30 for determining a treatment plan in addition to the treatment result information 28 of the patient body. See FIG. 43.

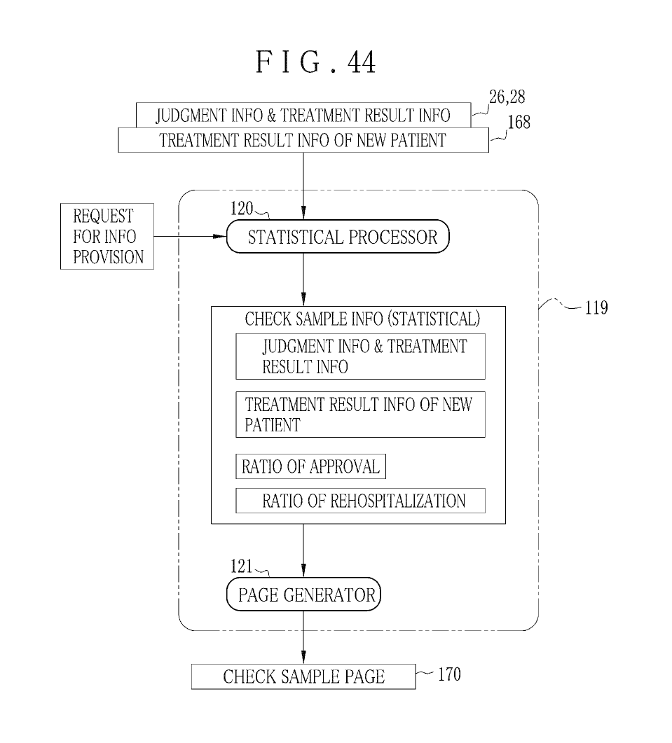

In FIG. 44, the statistical processor 120 in the information provider 119 outputs check sample information (analysis sample information) including treatment result information 168 for the new patient body (non-regular patient body) in addition to the judgment information 26 and the treatment result information 28. The statistical processor 120 processes the treatment result information 168 for the new patient body (non-regular patient body) in the statistical processing in the same manner as the judgment information 26 and the treatment result information 28 for the selective retrieval and determining the ratio of the rehospitalization.

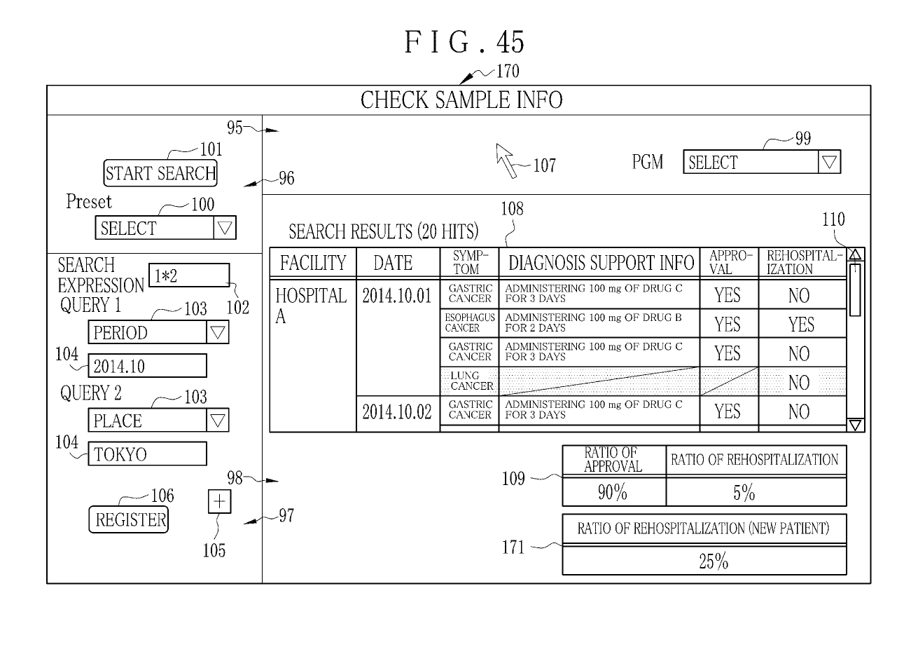

In FIG. 45, a check sample page 170 or analysis sample page is created by the page generator 121. The check sample page 170 is constituted by the check sample list 108 of the check sample page 92 in FIG. 16, treatment result information added to the check sample list 108 for the new patient body (non-regular patient body), the ratio display area 109, and a display area 171 for displaying a ratio of rehospitalization according to the treatment result information 168 for the new patient body. In the drawing, the treatment result information 168 for the new patient body is hatched to indicate a colored form for distinction from the treatment result information 28 of the patient body. Items of the diagnosis support information of the treatment result information 168 for the new patient body and an item of the judgment are blank areas. For the treatment result information 168 for the new patient body, a date of patient care of the new patient body is registered in an item of a data of the use.

Thus, collection of the second treatment result information 168 for the new patient body in addition to the treatment result information 28 of the patient body and provision of the treatment result information in a comparable manner make it possible to perform the performance monitoring of the diagnosis support program 30 to analyze achievement in view of improvement of the treatment result.

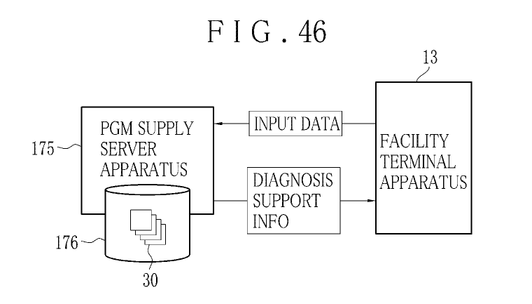

It is possible to download the diagnosis support program 30 from the center server 11 to the facility terminal apparatus 13 in the same manner as the first embodiment. Arithmetic operation and outputting the diagnosis support information with the diagnosis support program 30 are performed within the facility terminal apparatus 13. However, provision of the function of the diagnosis support program 30 can be performed as illustrated in FIG. 46.

In FIG. 46, a program supply server apparatus 175 is in a form of ASP (Application Service Provider), in which the diagnosis support program 30 is functioned in the facility terminal apparatus 13 without downloading to the facility terminal apparatus 13, unlike a structure in which the diagnosis support program 30 is downloaded to and run by the facility terminal apparatus 13. A program database 176 (DB) or storage medium is combined with the program supply server apparatus 175 for storing the diagnosis support program 30 uploaded by the vendor terminal apparatus 16 in the same form as the program database 35 of the first embodiment. A program controller is included in the CPU in the same form as the program controller 63 established in the CPU 52B of the facility terminal apparatus 13 in the first embodiment.

The facility terminal apparatus 13 transmits the input data of the diagnosis support program 30 to the program supply server apparatus 175. The program supply server apparatus 175 supplies the diagnosis support program 30 with the input data from the facility terminal apparatus 13, to perform data processing, so that diagnosis support information is output. The program supply server apparatus 175 transmits the diagnosis support information from the diagnosis support program 30 to the facility terminal apparatus 13.

Note that the center server 11 can include a component of the program supply server apparatus 175, or the program supply server apparatus 175 can be provided in the data center 10 in a separate manner from the center server 11. The program supply server apparatus 175 can be disposed with the hospital facility 12 or the vendor 15 without being disposed in the data center 10.

In the first embodiment, the second information collector 118 for collecting the treatment result information is discrete from the first information collector 117 for collecting the judgment information. However, the first and second information collectors 117 and 118 can be combined as a single information collector in the manner of the first information collector 125 of the second embodiment. Also, first and second servers can be used, the first server functioning for transferring the diagnosis support program 30 to be supplied (the program controller 116), the second server functioning for supplying check sample information (the first and second information collectors 117 and 118 and the information provider 119).

The provision of the check sample information (analysis sample information) is not limited to the distribution with the web of the above-described first embodiment. For example, a database (DB) for storing a file including the analysis same information is provided. Right for access to the database can be allocated to the hospital facility 12 or the vendors 15, to readout the file of the check sample information from the database. It is also possible automatically to transmit the file of the check sample information to the facility terminal apparatus 13 or the vendor terminal apparatus 16 by use of the file transfer protocol of a well-known type, such as FTPS (File Transfer Protocol over SSL/TLS) or the like. Furthermore, it is possible to use an electronic mail in place of the file transfer protocol.

The period for uploading (transmitting) the judgment information and treatment result information is not limited to one day according to the first embodiment, but can be time of other length, for example, one week, one month or one year. Also, treatment result information can be uploaded (transmitted) upon occurrence of a medical event to the patient body, such as rehospitalization.

Also, the diagnosis support program 30 can be directly downloaded to the facility terminal apparatus 13 from the vendor terminal apparatus 16 without use of the center server 11.

In the above embodiments, the information provider 119 provides the check sample information. However, the information provider 119 may not be used necessarily. The functions of the first and second information collectors 117 and 118 with importance can be provided. Also, it is possible to provide a function for automatically changing a processing algorithm of the diagnosis support program 30 according to the judgment information and treatment result information collected by the first and second information collectors 117 and 118. For example, it is possible to delete a processing algorithm for outputting diagnosis support information assuming that the judgment information of approval is “Yes” and assuming that occurrence of the rehospitalization is “Yes”.

Furthermore, feature of two or more of the above embodiments can be combined with one another. The scope of the present invention includes the computer-executable program and also a storage medium for storing the computer-executable program.

Note that the information collection of the invention is used for the performance monitoring of outputting information according to the diagnosis support program. The performance monitoring is performed by a user or person viewing the information displayed on a screen view or display page. Furthermore, it is possible to store check sample information as a result of the information collection, and to process the check sample information by a predetermined monitoring method, for example, a specialized monitoring program prepared previously, so as to perform the performance monitoring of the present invention. It is possible in the present invention to combine known techniques of the performance monitoring for use with the information collection.

According to one embodiment mode of the invention, a computer-executable program for information collection of information related to a diagnosis support program is provided, the diagnosis support program being for data processing of patient health data of a patient body and for outputting diagnosis support information for reference in determining a treatment plan for the patient body. The computer-executable program includes a first program code for collecting judgment information of approval or non-approval as to whether the treatment plan for the patient body for which the diagnosis support program is used is based on the diagnosis support information. A second program code is for collecting treatment result information of a treatment result of the patient body.

According to another embodiment mode of the invention, a user interface for performance indication related to a diagnosis support program is provided, the diagnosis support program being for data processing of patient health data of a patient body and for outputting diagnosis support information for reference in determining a treatment plan for the patient body. In the user interface, a first display area displays judgment information of approval or non-approval as to whether the treatment plan for the patient body for which the diagnosis support program is used is based on the diagnosis support information. A second display area displays treatment result information of a treatment result of the patient body.

According to another embodiment mode of the invention, the examination-related information includes at least one of a type of a symptom, size of a lesion, feature value of the lesion, location of the lesion, cure level of the symptom, type of a drug, dose of the drug, period of administration of the drug, test value of medical examination, and measured value of a vital sign.

Also, the surgery-related information includes at least one of a surgical procedure, incision method, surgical time, and blood loss.

Also, the statistical information includes at least one of a ratio of rehospitalization of the patient body, a ratio of cure of the patient body, a ratio of an increase or decrease of a cost of a hospitalization of the patient body with reference to a reference cost, an improvement rate of a symptom of the patient body, and an exacerbation rate of the symptom of the patient body.

Also, the attribute information includes at least one of an age, sex, height, weight, race, medical history, and residence of the patient body.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An information collection apparatus for collecting information related to a diagnosis support program for data processing of patient health data of a patient body and for outputting diagnosis support information for reference in determining a treatment plan for said patient body, comprising:
a first information collector for collecting judgment information of approval or non-approval as to whether said determined treatment plan is based on said diagnosis support information in relation to said patient body for which said diagnosis support program is used; and
a second information collector for collecting treatment result information of a treatment result of said patient body.

2. An information collection apparatus as defined in claim 1, further comprising an information provider for providing check sample information inclusive of said judgment information and said treatment result information in response to a request for information provision.

3. An information collection apparatus as defined in claim 1, further comprising a third information collector for collecting clinical data associated with said patient body, said diagnosis support information being based on said clinical data for output.

4. An information collection apparatus as defined in claim 3, wherein said clinical data is examination-related information of examination of said patient body.

5. An information collection apparatus as defined in claim 3, wherein said clinical data is surgery-related information of surgery of said patient body.

6. An information collection apparatus as defined in claim 2, further comprising a third information collector for collecting clinical data associated with said patient body, said diagnosis support information being based on said clinical data for output;
wherein said information provider further provides said check sample information inclusive of said clinical data in addition to said judgment information and said treatment result information.

7. An information collection apparatus as defined in claim 1, wherein said first information collector collects input history information of a history of an input of approval or non-approval of said treatment plan based on said diagnosis support information by way of said judgment information.

8. An information collection apparatus as defined in claim 1, further comprising:
a history information collector for collecting treatment history information of a history of treatment to said patient body among said patient health data;
a judgment unit for checking whether said treatment plan based on said diagnosis support information is approved or not according to said treatment history information;
wherein said first information collector collects a result of checking in said judgment unit for said judgment information.

9. An information collection apparatus as defined in claim 8, wherein said information provider further provides check sample information inclusive of said treatment history information in addition to said judgment information and said treatment result information, said treatment history information being information after judging non-approval of said treatment plan based on said diagnosis support information in said judgment unit.

10. An information collection apparatus as defined in claim 1, wherein said treatment result information includes information of at least one of occurrence or non-occurrence of rehospitalization of said patient body, a cost of hospitalization of said patient body, and a cure level of a symptom of said patient body.

11. An information collection apparatus as defined in claim 1, further comprising a statistical processor for statistically processing said judgment information and said treatment result information to output statistical information.

12. An information collection apparatus as defined in claim 11, wherein said statistical information is a ratio of approval or a ratio of non-approval of said treatment plan based on said diagnosis support information.

13. An information collection apparatus as defined in claim 11, wherein said statistical processor selectively retrieves said judgment information and said treatment result information according to a selection query, to obtain said statistical information.

14. An information collection apparatus as defined in claim 13, wherein said selection query is an item of attribute information of said patient body.

15. An information collection apparatus as defined in claim 11, further comprising a third information collector for collecting clinical data associated with said patient body, said diagnosis support information being based on said clinical data for output;
wherein said statistical processor further processes said clinical data statistically.

16. An information collection apparatus as defined in claim 8, further comprising a statistical processor for statistically processing said judgment information and said treatment result information to output statistical information;
wherein said statistical processor further processes said treatment history information statistically assuming that non-approval of a treatment plan based on said diagnosis support information is judged in said judgment unit.

17. An information collection apparatus as defined in claim 11, further comprising an information provider for providing check sample information inclusive of said judgment information, said treatment result information and said statistical information in response to a request for information provision.

18. An information collection apparatus as defined in claim 2, wherein said second information collector collects other treatment result information of a treatment result of a non-regular patient body being different from said patient body and unrelated with said diagnosis support program;
said information provider further provides said check sample information inclusive of said other treatment result information in addition to said judgment information and said treatment result information.

19. An operating method for an information collection apparatus for collecting information related to a diagnosis support program for data processing of patient health data of a patient body and for outputting diagnosis support information for reference in determining a treatment plan for said patient body, comprising steps of:
collecting judgment information of approval or non-approval as to whether said determined treatment plan is based on said diagnosis support information in relation to said patient body for which said diagnosis support program is used; and
collecting treatment result information of a treatment result of said patient body.

20. An information collection system comprising:
a facility terminal apparatus for using a diagnosis support program for data processing of patient health data of a patient body and for outputting diagnosis support information for reference in determining a treatment plan for said patient body;
an information collection server apparatus, connected with said facility terminal apparatus by network connection in a communicable manner, for collecting information related to said diagnosis support program;
said information collection server apparatus including:
a first information collector for collecting judgment information of approval or non-approval as to whether said determined treatment plan is based on said diagnosis support information in relation to said patient body for which said diagnosis support program is used; and
a second information collector for collecting treatment result information of a treatment result of said patient body.
